(19) United States
(12) Patent Application Publication
(10) Pub. No.: US 2020/0386932 A1
(43) Pub. Date: Dec. 10, 2020

(54) OPTICAL ELEMENT

(71) Applicant: FUJIFILM Corporation, Tokyo (JP)

(72) Inventors: Hiroshi SATO, Minami-ashigara-shi (JP); Yukito SAITOH, Minami-ashigara-shi (JP)

(73) Assignee: FUJIFILM Corporation, Tokyo (JP)

(21) Appl. No.: 17/002,344

(22) Filed: Aug. 25, 2020

Related U.S. Application Data
(63) Continuation of application No. PCT/JP2019/006781, filed on Feb. 22, 2019.

(30) Foreign Application Priority Data
Feb. 26, 2018 (JP) 2018-031905

(51) Int. Cl. G02B 5/30

(52) U.S. Cl. CPC G02B 5/3016

(57) ABSTRACT

Provided is an optical element that reflects light using a cholesteric liquid crystal layer, in which the amount of light reflected is large. The cholesteric liquid crystal layer has a liquid crystal alignment pattern in which a direction of an optical axis derived from a liquid crystal compound changes while continuously rotating in at least one in-plane direction, at least one combination of two cholesteric liquid crystal layers having the same turning direction of circularly polarized light to be reflected and including an overlapping portion in at least a part of selective reflection wavelength ranges, and a λ/2 plate is provided between two cholesteric liquid crystal layers forming the combination of the cholesteric liquid crystal layers.

### CROSS-REFERENCE TO RELATED APPLICATIONS

This application is a Continuation of PCT International Application No. PCT/JP2019/006781 filed on Feb. 22, 2019, which claims priority under 35 U.S.C. § 119(a) to Japanese Patent Application No. 2018-031905 filed on Feb. 26, 2018. The above application is hereby expressly incorporated by reference, in its entirety, into the present application.

### BACKGROUND OF THE INVENTION

### 1. Field of the Invention

The present invention relates to an optical element that reflects light.

### 2. Description of the Related Art

A screen using a cholesteric liquid crystal layer that is obtained by immobilizing a cholesteric liquid crystalline phase is known.

The cholesteric liquid crystal layer has wavelength selectivity in reflection and reflects only circularly polarized light in a specific turning direction. That is, for example, the cholesteric liquid crystal layer reflects only right circularly polarized light of red light and allows transmission of the other light.

By using the cholesteric liquid crystal layer, for example, a transparent projection screen through which an opposite side can be seen can be realized.

Light reflection by the cholesteric liquid crystal layer is specular reflection. For example, light incident into a cholesteric liquid crystal layer from a normal direction (front side) is reflected in the normal direction of the cholesteric liquid crystal layer.

Therefore, the application range of the cholesteric liquid crystal layer is limited.

On the other hand, WO2016/194961A describes a reflective structure including a cholesteric liquid crystal layer, in which light can be reflected with an angle in a predetermined direction with respect to specular reflection.

This reflective structure includes a plurality of helical structures each of which extends in a predetermined direction. In addition, this reflective structure includes: a first incidence surface that intersects the predetermined direction and into which light is incident; and a reflecting surface that intersects the predetermined direction and reflects the light incident from the first incidence surface, in which the first incidence surface includes one of two end portions in each of the plurality of helical structures. In addition, each of the plurality of helical structures includes a plurality of structural units that lies in the predetermined direction, and each of the plurality of structural units includes a plurality of elements that are helically turned and laminated. In addition, each of the plurality of structural units includes a first end portion and a second end portion, the second end portion of one structural unit among structural units adjacent to each other in the predetermined direction forms the first end portion of the other structural unit, and an alignment direction of the elements positioned in the plurality of first end portions included in the plurality of helical structures are aligned. Further, the reflecting surface includes at least one first end portion included in each of the plurality of helical structures and is not parallel to the first incidence surface.

### SUMMARY OF THE INVENTION

The reflective structure (cholesteric liquid crystal layer) described in WO2016/194961A includes the reflecting surface that is not parallel to the first incidence surface.

Therefore, the reflective structure described in WO2016/194961A reflects incident light with an angle in the predetermined direction with respect to specular reflection instead of specular reflection. For example, in the cholesteric liquid crystal layer described in WO2016/194961A, light incident from the normal direction is reflected with an angle with respect to the normal direction instead of being reflected in the normal direction.

As a result, in WO2016/194961A, the application range of the reflective structure including the cholesteric liquid crystal layer can be extended.

However, the cholesteric liquid crystal layer reflects only one of right circularly polarized light or left circularly polarized light. Therefore, in a case where it is desired to efficiently use light incident into the cholesteric liquid crystal layer, there is a limit on the amount of light that can be used. In addition, using the cholesteric liquid crystal layer, incident light can be reflected with an angle in the predetermined direction with respect to specular reflection. Further, the realization of an optical element having a large amount of light reflected is desired.

An object of the present invention is to solve the problem in the related art and to provide an optical element that reflects light using a cholesteric liquid crystal layer, in which incident light can be reflected with an angle in the predetermined direction with respect to specular reflection. Further, another object of the present invention is to provide an optical element having a large amount of light reflected.

In order to achieve the object, the present invention has the following configurations.

[1] An optical element comprising a plurality of cholesteric liquid crystal layers and a) λ/2 plate that are laminated, each of the cholesteric liquid crystal layers being obtained by immobilizing a cholesteric liquid crystalline phase,

in which the cholesteric liquid crystal layer has a liquid crystal alignment pattern in which a direction of an optical axis derived from a liquid crystal compound changes while continuously rotating in at least one in-plane direction,

in a case where, in the liquid crystal alignment pattern, a length over which the direction of the optical axis derived from the liquid crystal compound rotates by 180° in the in-plane direction in which the direction of the optical axis derived from the liquid crystal compound changes while continuously rotating is set as a single period,

at least one reflecting layer pair is provided, the reflecting layer pair being a combination of two cholesteric liquid crystal layers having the same turning direction of circularly polarized light to be reflected and including an overlapping portion in at least a part of selective reflection wavelength ranges, and

the λ/2 plate is provided between the cholesteric liquid crystal layers forming the reflecting layer pair.

[2] The optical element according to [1],

in which the cholesteric liquid crystal layers forming the reflecting layer pair have the same length of the single period.

[3] The optical element according to [1] or [2],

in which the cholesteric liquid crystal layers forming the reflecting layer pair have the same rotation direction and the same change direction of the optical axis derived from the liquid crystal compound.

[4] The optical element according to any one of [1] to [3],

in which in a case where a range between two wavelengths of a half value transmittance of the cholesteric liquid crystal layers forming the reflecting layer pair is represented by Δλₕ, a difference between selective reflection center wavelengths is 0.8×Δλₕ nm or less.

[5] The optical element according to any one of [1] to [4],

in which the cholesteric liquid crystal layers forming the reflecting layer pair are formed of the same cholesteric liquid crystal layer.

[6] The optical element according to any one of [1] to [5],

in which a plurality of reflecting layer pairs are provided, and

selective reflection center wavelengths of the cholesteric liquid crystal layers forming the reflecting layer pair vary between the different reflecting layer pairs.

[7] The optical element according to [6],

in which the single periods of the cholesteric liquid crystal layers forming the reflecting layer pair vary between on the different reflecting layer pairs.

[8] The optical element according to [7],

in which a permutation of lengths of selective reflection center wavelengths and a permutation of lengths of the single periods in the cholesteric liquid crystal layers forming the reflecting layer pair match each other in the different reflecting layer pairs.

[9] The optical element according to any one of [6] to [8],

wherein the λ/2 plate is provided between the cholesteric liquid crystal layers forming the reflecting layer pair for each of the reflecting layer pairs.

[10] The optical element according to any one of [6] to [8] comprising:

two laminates in which a plurality of cholesteric liquid crystal layers having different selective reflection center wavelengths are laminated, each of the laminates consisting of the same cholesteric liquid crystal layer,

in which the λ/2 plate is provided between the two laminates.

The optical element according to an aspect of the present invention is an optical element including a cholesteric liquid crystal layer, in which incident light can be reflected with an angle in the predetermined direction with respect to specular reflection, and the amount of light reflected is also high.

### BRIEF DESCRIPTION OF THE DRAWINGS

FIG. 1 is a conceptual diagram illustrating an example of an optical element according to the present invention.

FIG. 2 is a conceptual diagram showing a cholesteric liquid crystal layer of the optical element shown in FIG. 1.

FIG. 3 is a plan view showing the cholesteric liquid crystal layer of the optical element shown in FIG. 1.

FIG. 4 is a conceptual diagram showing an action of the cholesteric liquid crystal layer of the optical element shown in FIG. 1.

FIG. 5 is a conceptual diagram showing one example of an exposure device that exposes an alignment film of the optical element shown in FIG. 1.

FIG. 6 is a graph showing the optical element according to the present invention.

FIG. 7 is a conceptual diagram illustrating an action of the optical element shown in FIG. 1.

FIG. 8 is a conceptual diagram showing another example of the cholesteric liquid crystal layer of the optical element according to the present invention.

FIG. 9 is a conceptual diagram showing another example of the cholesteric liquid crystal layer of the optical element according to the present invention.

FIG. 10 is a plan view showing still another example of the cholesteric liquid crystal layer of the optical element according to the present invention.

FIG. 11 is a conceptual diagram showing another example of the exposure device that exposes the alignment film of the optical element shown in FIG. 10.

FIG. 12 is a conceptual diagram showing AR glasses included in the optical element shown in FIG. 8.

FIG. 13 is a conceptual diagram showing a method of measuring a light intensity.

### DESCRIPTION OF THE PREFERRED EMBODIMENTS

Hereinafter, an optical element and a light guide element according to an embodiment of the present invention will be described in detail based on preferable embodiments shown in the accompanying drawings.

In this specification, numerical ranges represented by “to” include numerical values before and after “to” as lower limit values and upper limit values.

In this specification, “(meth)acrylate” represents “either or both of acrylate and methacrylate”.

In this specification, the meaning of “the same” includes a case where an error range is generally allowable in the technical field. In addition, in this specification, the meaning of “all”, “entire”, or “entire surface” includes not only 100% but also a case where an error range is generally allowable in the technical field, for example, 99% or more, 95% or more, or 90% or more.

In this specification, visible light refers to light which can be observed by human eyes among electromagnetic waves and refers to light in a wavelength range of 380 to 780 nm. Invisible light refers to light in a wavelength range of shorter than 380 nm or longer than 780 nm.

In addition, although not limited thereto, in visible light, light in a wavelength range of 420 to 490 nm refers to blue light, light in a wavelength range of 495 to 570 nm refers to green light, and light in a wavelength range of 620 to 750 nm refers to red light.

In this specification, a selective reflection center wavelength refers to an average value of two wavelengths at which, in a case where a minimum value of a transmittance of a target object (member) is represented by Tmin (%), a half value transmittance: T½ (%) represented by the following expression is exhibited.

T1/2=100−(100−T min)÷2 Expression for obtaining Half Value Transmittance:

In addition, selective reflection center wavelengths of a plurality of layers being “equal” does not represent that the selective reflection center wavelengths are exactly equal, and error is allowed in a range where there are no optical effects. Specifically, selective reflection center wavelengths of a plurality of objects being “equal” represents a difference between the selective reflection center wavelengths of the respective objects is 20 nm or less, and this difference is preferably 15 nm or less and more preferably 10 nm or less.

In the this specification, Re(λ) represents an in-plane retardation at a wavelength λ. Unless specified otherwise, the wavelength λ refers to 550 nm.

In this specification, Re(λ) is a value measured at the wavelength λ using AxoScan (manufactured by Axometrics, Inc.). By inputting an average refractive index ((nx+ny+nz)/3) and a thickness (d (μm)) to AxoScan, the following expressions can be calculated.

Slow Axis Direction (°)

Re(λ)=R0(λ)

R0(λ) is expressed as a numerical value calculated by AxoScan and represents Re(λ).

An optical element according to the embodiment of the present invention is a light reflection element that reflects incident light, the optical element comprising a plurality of cholesteric liquid crystal layers and a λ/2 plate that are laminated, and each of the cholesteric liquid crystal layers being obtained by immobilizing a cholesteric liquid crystalline phase.

In the optical element according to the embodiment of the present invention, the cholesteric liquid crystal layer has a liquid crystal alignment pattern in which a direction of an optical axis derived from a liquid crystal compound changes while continuously rotating in at least one in-plane direction. Here, in the liquid crystal alignment pattern, a length over which the direction of the optical axis rotates by 180° in the in-plane direction in which the direction of the optical axis changes while continuously rotating is set as a single period.

In the optical element according to the embodiment of the present invention, at least one (one set; one pair) combination (in the present invention, a reflecting layer pair) of two cholesteric liquid crystal layers having the same turning direction of circularly polarized light to be reflected and including an overlapping portion in at least a part of selective reflection wavelength ranges is provided, and a λ/2 plate is provided between two cholesteric liquid crystal layers forming the combination of the cholesteric liquid crystal layers.

Although described in detail below, with the optical element according to the embodiment of the present invention having the above-described structure, incident light can be reflected with an angle in the predetermined direction with respect to specular reflection, and the amount of light reflected is also larger than that of an optical element including a cholesteric reflecting layer in the related art.

### First Embodiment

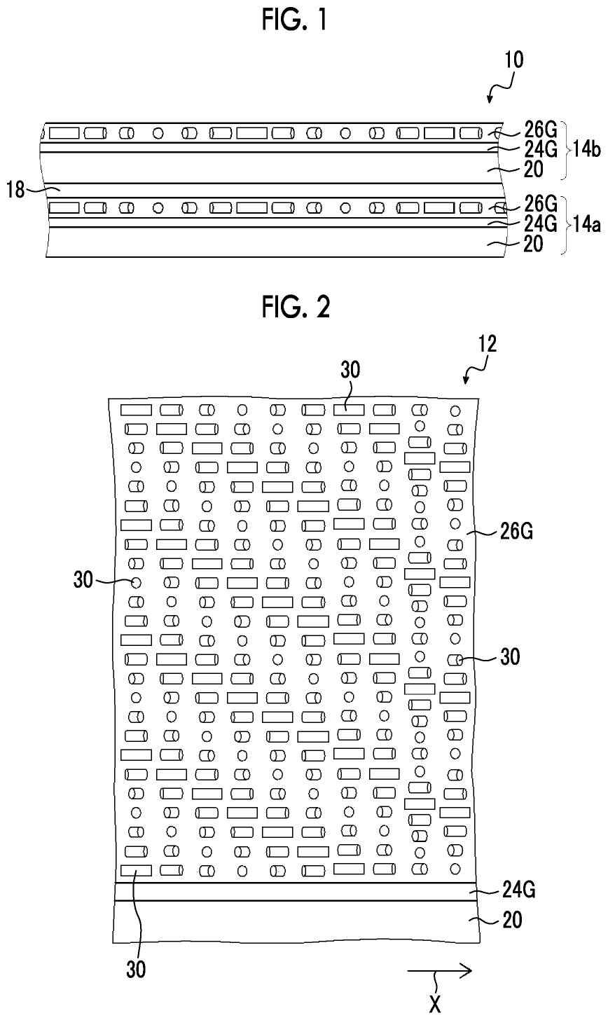

FIG. 1 is a diagram conceptually showing an example of the optical element according to the embodiment of the present invention.

An optical element 10 shown in the drawing is an optical element that selectively reflects green light, and includes a first G reflecting layer 14a, a λ/2 plate 18, and a second G reflecting layer 14b.

In the optical element 10, each of the first G reflecting layer 14a and the second G reflecting layer 14b includes a support 20, a G alignment film 24G, and a G reflection cholesteric liquid crystal layer 26G. In a preferable aspect of the optical element 10, the first G reflecting layer 14a and the second G reflecting layer 14b are the same.

Although not shown in the drawing, the first G reflecting layer 14a and the λ/2 plate 18 are bonded through an bonding layer provided therebetween, and the λ/2 plate 18 and the second G reflecting layer 14b are bonded through an bonding layer provided therebetween.

In the present invention, as the bonding layer, any layer formed of one of various well-known materials can be used as long as it is a layer that can bond materials as bonding targets. The bonding layer may be a layer formed of an adhesive that has fluidity during bonding and becomes a solid after bonding, a layer formed of a pressure sensitive adhesive that is a gel-like (rubber-like) flexible solid during bonding and of which the gel state does not change after bonding, or a layer formed of a material having characteristics of both the adhesive and the pressure sensitive adhesive. Accordingly, the bonding layer may be any well-known layer that is used for bonding a sheet-shaped material in an optical device or an optical element, for example, an optical clear adhesive (OCA), an optically transparent double-sided tape, or an ultraviolet curable resin.

Alternatively, instead of bonding the layers using the bonding layers, the first G reflecting layer 14a, the λ/2 plate 18, and the second G reflecting layer 14b may be laminated and held by a frame, a holding device, or the like to form the optical element according to the embodiment of the present invention.

In addition, the optical element 10 shown in the drawing includes the support 20 for each of the reflecting layers. However, the optical element according to the embodiment of the present invention does not necessarily include the support 20 for each of the reflecting layers.

For example, in the optical element according to the embodiment of the present invention, the λ/2 plate 18 may be formed on a surface of the first G reflecting layer 14a (the G reflection cholesteric liquid crystal layer 26G), the G alignment film 24G of the second G reflecting layer 14b may be formed on a surface of the λ/2 plate 18, and the G reflection cholesteric liquid crystal layer 26G of the second G reflecting layer 14b may be formed on a surface of the G alignment film 24G. Alternatively, the support 20 of the first G reflecting layer 14a may be removed from the above-described configuration such that only the alignment film, the cholesteric liquid crystal layer, and the λ/2 plate or only the cholesteric liquid crystal layer and the λ/2 plate may form the optical element according to the embodiment of the present invention.

Further, in the optical element 10 in the example shown in the drawing, the λ/2 plate 18 includes the support. However, the λ/2 plate 18 may be formed on a surface of the same support as the support 20.

That is, the optical element according to the embodiment of the present invention can adopt various layer configurations as long as it includes a plurality of cholesteric liquid crystal layers and a λ/2 plate, in which the cholesteric liquid crystal layer has a liquid crystal alignment pattern in which a direction of an optical axis derived from a liquid crystal compound rotates in one in-plane direction, at least one combination of two cholesteric liquid crystal layers having the same turning direction of circularly polarized light to be reflected and including an overlapping portion in at least a part of selective reflection wavelength ranges, and the λ/2 plate is provided between the cholesteric liquid crystal layers of the combination.

The above-described point can be applied to all the optical elements according to respective aspects of the present invention described below.

<Support>

In the first G reflecting layer 14a and the second G reflecting layer 14b, the supports 20 represent the G alignment film 24G and the G reflection cholesteric liquid crystal layer 26G, respectively.

As the support 20, various sheet-shaped materials (films or plate-shaped materials) can be used as long as they can support the G alignment film 24G and the G reflection cholesteric liquid crystal layer 26G.

A transmittance of the support 20 with respect to corresponding light is preferably 50% or higher, more preferably 70% or higher, and still more preferably 85% or higher.

The thickness of the support 20 is not particularly limited and may be appropriately set depending on the use of the optical element 10, a material for forming the support 20, and the like in a range where the G alignment film 24G and the G reflection cholesteric liquid crystal layer 26G can be supported.

The thickness of the support 20 is preferably 1 to 1000 μm, more preferably 3 to 250 μm, and still more preferably 5 to 150 μm.

The support 20 may have a single-layer structure or a multi-layer structure.

In a case where the support 20 has a single-layer structure, examples thereof include supports formed of glass, triacetyl cellulose (TAC), polyethylene terephthalate (PET), polycarbonates, polyvinyl chloride, acryl, polyolefin, and the like. In a case where the support 20 has a multi-layer structure, examples thereof include a support including: one of the above-described supports having a single-layer structure that is provided as a substrate; and another layer that is provided on a surface of the substrate.

<Alignment Film>

In the first G reflecting layer 14a and the second G reflecting layer 14b, the G alignment film 24G is formed on the surface of the support 20. The G alignment film 24G is an alignment film for aligning the liquid crystal compound 30 to a predetermined liquid crystal alignment pattern during the formation of the G reflection cholesteric liquid crystal layers 26G of the first G reflecting layer 14a and the second G reflecting layer 14b.

The description regarding the G alignment film 24G and the G reflection cholesteric liquid crystal layer 26G are also applicable to alignment films provided in an R reflection member 12, a B reflection member 16, and the like. Accordingly, in the following description, in a case where it is not necessary to distinguish the G alignment films 24G of the first G reflecting layer 14a and the second G reflecting layer 14b from another alignment film, the alignment films 24G will also be simply referred to as “alignment film”. In a case where it is not necessary to distinguish the G reflection cholesteric liquid crystal layers 26G of the first G reflecting layer 14a and the second G reflecting layer 14B from another cholesteric liquid crystal layer, the G reflection cholesteric liquid crystal layers 26G will also be simply referred to as “cholesteric liquid crystal layer”.

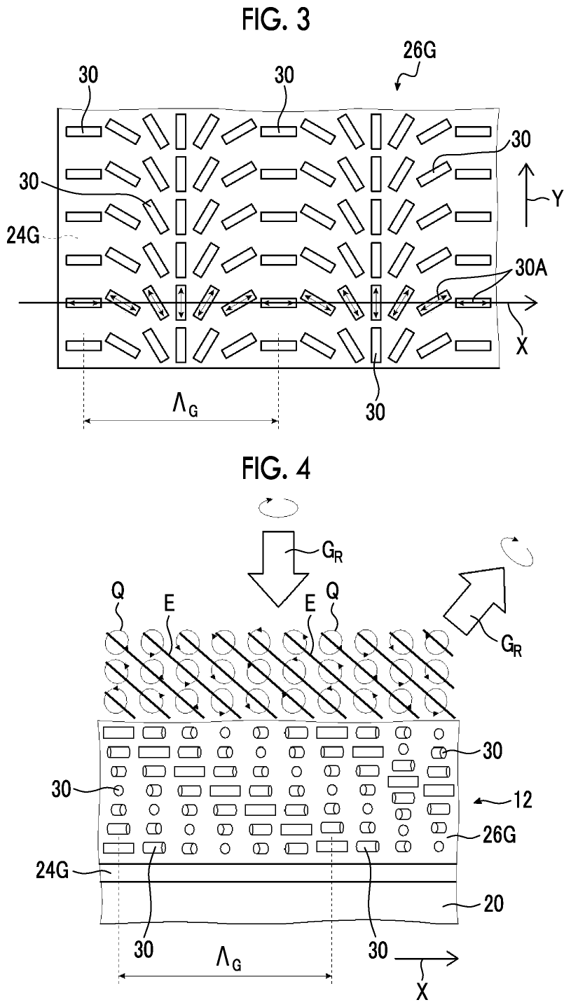

Although described below, in the optical element 10 according to the embodiment of the present invention, the cholesteric liquid crystal layer has a liquid crystal alignment pattern in which a direction of an optical axis 30A (refer to FIG. 3) derived from the liquid crystal compound 30 changes while continuously rotating in one in-plane direction.

In addition, in the liquid crystal alignment pattern, a length over which the direction of the optical axis 30A rotates by 180° in the in-plane direction in which the direction of the optical axis 30A changes while continuously rotating is set as a single period A (a rotation period of the optical axis). In a preferable aspect of the optical element 10, the G reflection cholesteric liquid crystal layers 26G of the first G reflecting layer 14a and the second G reflecting layer 14b have the same length of the single period in the liquid crystal alignment pattern. Further, in a preferable aspect of the optical element 10, the first G reflecting layer 14a and the second G reflecting layer 14b have the same rotation direction of the optical axis 30A and the same direction in which the optical axis 30A changes while rotating in the liquid crystal alignment pattern of the G reflection cholesteric liquid crystal layer 26G.

With the above-described configuration, the first G reflecting layer 14a and the second G reflecting layer 14b can reflect green light in the same direction.

In the following description, “the direction of the optical axis 30A rotates” will also be referred to as “the optical axis 30A rotates”.

As the alignment film, various well-known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as w-tricosanoic acid, dioctadecylmethylammonium chloride, or methyl stearate.

The alignment film formed by a rubbing treatment can be formed by rubbing a surface of a polymer layer with paper or fabric in a given direction multiple times.

As the material used for the alignment film, for example, a material for forming polyimide, polyvinyl alcohol, a polymer having a polymerizable group described in JP1997-152509A (JP-H9-152509A), or an alignment film such as JP2005-097377A, JP2005-099228A, and JP2005-128503A is preferable.

In the optical element 10 according to the embodiment of the present invention, for example, the alignment film can be suitably used as a so-called photo-alignment film obtained by irradiating a photo-alignable material with polarized light or non-polarized light. That is, in the optical element 10 according to the embodiment of the present invention, a photo-alignment film that is formed by applying a photo-alignable material to the support 20 is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignable material used in the photo-alignment film that can be used in the present invention include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate (cinnamic acid) compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitability used.

The thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method of forming the alignment film is not limited. Any one of various well-known methods corresponding to a material for forming the alignment film can be used. For example, a method including: applying the alignment film to a surface of the support 20; drying the applied alignment film; and exposing the alignment film to laser light to form an alignment pattern can be used.

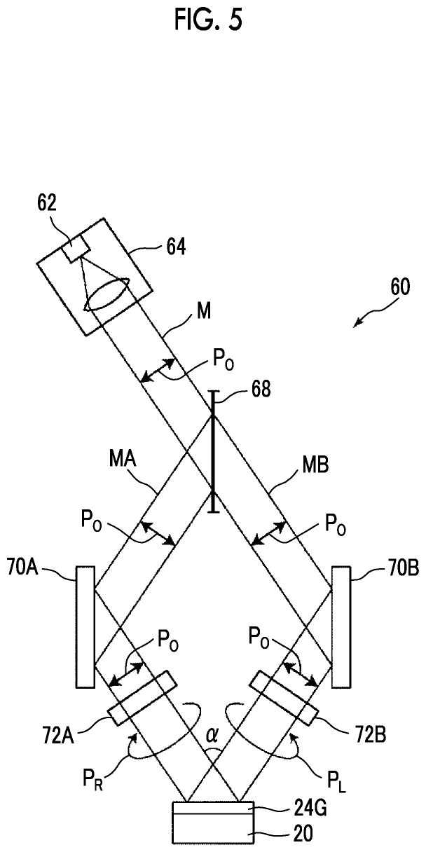

FIG. 5 conceptually shows an example of an exposure device that exposes the alignment film to form an alignment pattern. FIG. 5 shows the example of forming the G alignment films 24G of the first G reflecting layer 14a and the second G reflecting layer 14b. Regarding an R alignment film 24R and a B alignment film 24B described below, an alignment pattern can also be formed using the same exposure device.

An exposure device 60 shown in FIG. 5 includes: a light source 64 that includes a laser 62; a polarization beam splitter 68 that splits laser light M emitted from the laser 62 into two beams MA and MB; mirrors 70A and 70B that are disposed on optical paths of the splitted two beams MA and MB; and λ/4 plates 72A and 72B.

Although not shown in the drawing, the light source 64 emits linearly polarized light P₀. The λ/4 plates 72A and 72B has optical axes perpendicular to each other. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}.

The support 20 including the R alignment film 24R on which the alignment pattern is not yet formed is disposed at an exposed portion, the two beams MA and MB intersect and interfere each other on the R alignment film 24R, and the G alignment film 24G is irradiated with and exposed to the interference light.

Due to the interference at this time, the polarization state of light with which the G alignment film 24G is irradiated periodically changes according to interference fringes. As a result, in the G alignment film 24G, an alignment pattern in which the alignment state periodically changes can be obtained.

In the exposure device 60, by changing an intersection angle α between the two beams MA and MB, the period of the alignment pattern can be adjusted. That is, by adjusting the intersection angle α in the exposure device 60, in the alignment pattern in which the optical axis 30A derived from the liquid crystal compound 30 continuously rotates in the in-plane direction, the length of the single period over which the optical axis 30A rotates by 180° in the in-plane direction in which the optical axis 30A rotates can be adjusted.

By forming the cholesteric liquid crystal layer on the alignment film having the alignment pattern in which the alignment state periodically changes, as described below, the G reflection cholesteric liquid crystal layer 26G having the liquid crystal alignment pattern in which the optical axis 30A derived from the liquid crystal compound 30 continuously rotates in the in-plane direction can be formed.

In addition, by rotating the optical axes of the λ/4 plates 72A and 72B by 90°, respectively, the rotation direction of the optical axis 30A can be reversed.

In the optical element according to the embodiment of the present invention, the alignment film is provided as a preferable aspect and is not an essential component.

For example, the following configuration can also be adopted, in which, by forming the alignment pattern on the support 20 using a method of rubbing the support 20, a method of processing the support 20 with laser light or the like, or the like, the cholesteric liquid crystal layer or the like has the liquid crystal alignment pattern in which the direction of the optical axis 30A derived from the liquid crystal compound 30 changes while continuously rotating in at least one in-plane direction.

<Cholesteric Liquid Crystal Layer>

In the first G reflecting layer 14a and the second G reflecting layer 14b, the G reflection cholesteric liquid crystal layer 26G is formed on the surface of the G alignment film 24G.

In FIG. 1, in order to simplify the drawing and to clarify the configuration of the optical element 10, only the liquid crystal compound 30 (liquid crystal compound molecules) on the surface of the alignment film in the G reflection cholesteric liquid crystal layer 26G is conceptually shown. However, as conceptually shown in FIG. 2, the G reflection cholesteric liquid crystal layer 26G has a helical structure in which the liquid crystal compound 30 is helically turned and laminated as in a cholesteric liquid crystal layer obtained by immobilizing a typical cholesteric liquid crystalline phase. In the helical structure, a configuration in which the liquid crystal compound 30 is helically rotated once (rotated by 360) and laminated is set as one helical pitch, and plural pitches of the helically turned liquid crystal compound 30 are laminated. This point is also applicable to an R reflection cholesteric liquid crystal layer 26R and a B reflection cholesteric liquid crystal layer 26B.

The cholesteric liquid crystal layer has wavelength selective reflection properties.

The G reflection cholesteric liquid crystal layer 26G reflects right circularly polarized light G_{R} of green light and allows transmission of the other light. Therefore, the G reflection cholesteric liquid crystal layer 26G has a selective reflection center wavelength in a green light wavelength range.

The G reflection cholesteric liquid crystal layer 26G is obtained by immobilizing a cholesteric liquid crystalline phase. That is, the G reflection cholesteric liquid crystal layer 26G is a layer formed of the liquid crystal compound 30 (liquid crystal material) having a cholesteric structure.

<<Cholesteric Liquid Crystalline Phase>>

It is known that the cholesteric liquid crystalline phase exhibits selective reflection properties at a specific wavelength. The center wavelength λ of selective reflection (selective reflection center wavelength λ) depends on a pitch P of a helical structure in the cholesteric liquid crystalline phase and satisfies a relationship of λ=n×P with an average refractive index n of the cholesteric liquid crystalline phase. Therefore, the selective reflection center wavelength can be adjusted by adjusting the pitch of the helical structure. The pitch of the cholesteric liquid crystalline phase depends on the kind of a chiral agent which is used in combination of a liquid crystal compound during the formation of the cholesteric liquid crystal layer, or the concentration of the chiral agent added. Therefore, a desired pitch can be obtained by adjusting the kind and concentration of the chiral agent. That is, the pitch P of the helical structure in the cholesteric liquid crystalline phase refers to a helical period in the helical structure of the cholesteric liquid crystalline phase.

The details of the adjustment of the pitch can be found in “Fuji Film Research&Development” No. 50 (2005), pp. 60 to 63. As a method of measuring a helical sense and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The cholesteric liquid crystalline phase exhibits selective reflection properties with respect to left or circularly polarized light at a specific wavelength. Whether or not the reflected light is right circularly polarized light or left circularly polarized light is determined depending on a helical twisting direction (sense) of the cholesteric liquid crystalline phase. Regarding the selective reflection of the circularly polarized light by the cholesteric liquid crystalline phase, in a case where the helical turning direction of the cholesteric liquid crystalline phase is right, right circularly polarized light is reflected, and in a case where the helical twisting direction of the cholesteric liquid crystalline phase is left, left circularly polarized light is reflected.

Accordingly, in the optical element 10 shown in the drawing, the cholesteric liquid crystal layer is a layer obtained by immobilizing a right-twisted cholesteric liquid crystalline phase.

A turning direction of the cholesteric liquid crystalline phase can be adjusted by adjusting the kind of the liquid crystal compound that forms the cholesteric liquid crystal layer and/or the kind of the chiral agent to be added.

In addition, a half-width Δλ (nm) of a selective reflection range (circularly polarized light reflection range) where selective reflection is exhibited depends on Δn of the cholesteric liquid crystalline phase and the helical pitch P and complies with a relationship of Δλ=Δn×P. Therefore, the width of the selective reflection range can be controlled by adjusting Δn. Δn can be adjusted by adjusting a kind of a liquid crystal compound for forming the cholesteric liquid crystal layer and a mixing ratio thereof, and a temperature during alignment immobilization.

The half-width of the reflection wavelength range is adjusted depending on the application of the optical element 10 and is, for example, 10 to 500 nm and preferably 20 to 300 nm and more preferably 30 to 100 nm.

<<Method of Forming Cholesteric Liquid Crystal Layer>>

The cholesteric liquid crystal layer can be formed by immobilizing a cholesteric liquid crystalline phase in a layer shape.

The structure in which a cholesteric liquid crystalline phase is immobilized may be a structure in which the alignment of the liquid crystal compound as a cholesteric liquid crystalline phase is immobilized. Typically, it is preferable that the structure in which a cholesteric liquid crystalline phase is immobilized is a structure which is obtained by making the polymerizable liquid crystal compound to be in a state where a cholesteric liquid crystalline phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a cholesteric liquid crystalline phase is immobilized is not particularly limited as long as the optical characteristics of the cholesteric liquid crystalline phase are maintained, and the liquid crystal compound 30 in the cholesteric liquid crystal layer does not necessarily exhibit liquid crystallinity. For example, the molecular weight of the polymerizable liquid crystal compound may be increased by a curing reaction such that the liquid crystallinity thereof is lost.

Examples of a material used for forming the cholesteric liquid crystal layer obtained by immobilizing a cholesteric liquid crystalline phase include a liquid crystal composition including a liquid crystal compound. It is preferable that the liquid crystal compound is a polymerizable liquid crystal compound.

In addition, the liquid crystal composition used for forming the cholesteric liquid crystal layer may further include a surfactant and a chiral agent.

—Polymerizable Liquid Crystal Compound—

The polymerizable liquid crystal compound may be a rod-shaped liquid crystal compound or a disk-shaped liquid crystal compound.

Examples of the rod-shaped polymerizable liquid crystal compound for forming the cholesteric liquid crystalline phase include a rod-shaped nematic liquid crystal compound. As the rod-shaped nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a high-molecular-weight liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

Examples of the polymerizable liquid crystal compound include compounds described in Makromol. Chem. (1989), Vol. 190, p. 2255, Advanced Materials (1993), Vol. 5, p. 107, U.S. Pat. Nos. 4,683,327A, 5,622,648A, 5,770,107A, WO95/22586, WO95/24455, WO97/00600, WO98/23580, WO98/52905, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. In a case where two or more polymerizable liquid crystal compounds are used in combination, the alignment temperature can be decreased.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described high-molecular-weight liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

—Disk-Shaped Liquid Crystal Compound—

As the disk-shaped liquid crystal compound, for example, compounds described in JP2007-108732A and JP2010-244038A can be preferably used.

In addition, the addition amount of the polymerizable liquid crystal compound in the liquid crystal composition is preferably 75% to 99.9 mass %, more preferably 80% to 99 mass %, and still more preferably 85% to 90 mass % with respect to the solid content mass (mass excluding a solvent) of the liquid crystal composition.

—Surfactant—

The liquid crystal composition used for forming the cholesteric liquid crystal layer may include a surfactant.

It is preferable that the surfactant is a compound that can function as an alignment controller contributing to the stable or rapid formation of a cholesteric liquid crystalline phase with planar alignment. Examples of the surfactant include a silicone surfactant and a fluorine surfactant. Among these, a fluorine surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and “0082” to “0085” of JP2002-129162A, and fluorine (meth)acrylate polymers described in paragraphs “0018” to “0043” of JP2007-272185A.

As the surfactant, one kind may be used alone, or two or more kinds may be used in combination.

As the fluorine surfactant, a compound described in paragraphs “0082” to “0090” of JP2014-119605A is preferable.

The addition amount of the surfactant in the liquid crystal composition is preferably 0.01 to 10 mass %, more preferably 0.01 to 5 mass %, and still more preferably 0.02 to 1 mass % with respect to the total mass of the liquid crystal compound.

—Chiral Agent (Optically Active Compound)—

The chiral agent has a function of causing a helical structure of a cholesteric liquid crystalline phase to be formed. The chiral agent may be selected depending on the purpose because a helical twisting direction or a helical pitch derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for turned nematic (TN) or super turned nematic (STN), p. 199), isosorbide, or an isomannide derivative can be used.

In general, the chiral agent includes an asymmetric carbon atom. However, an axially asymmetric compound or a surface asymmetric compound not having an asymmetric carbon atom can also be used as a chiral agent. Examples of the axially asymmetric compound or the surface asymmetric compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group included in the polymerizable chiral agent is the same as the polymerizable group included in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a pattern having a desired reflection wavelength corresponding to an emission wavelength can be formed by irradiation of an actinic ray or the like through a photomask after coating and alignment, which is preferable. As the photoisomerization group, an isomerization portion of a photochromic compound, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01% to 200 mol % and more preferably 1% to 30 mol % with respect to the content molar amount of the liquid crystal compound.

—Polymerization Initiator—

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator is a photopolymerization initiator which initiates a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 to 12 mass % with respect to the content of the liquid crystal compound.

—Crosslinking Agent—

In order to improve the film hardness after curing and to improve durability, the liquid crystal composition may optionally include a crosslinking agent. As the crosslinking agent, a curing agent which can perform curing with ultraviolet light, heat, moisture, or the like can be preferably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. Among these crosslinking agents, one kind may be used alone, or two or more kinds may be used in combination.

The content of the crosslinking agent is preferably 3% to 20 mass % and more preferably 5% to 15 mass % with respect to the solid content mass of the liquid crystal composition. In a case where the content of the crosslinking agent is in the above-described range, an effect of improving a crosslinking density can be easily obtained, and the stability of a cholesteric liquid crystalline phase is further improved.

—Other Additives—

Optionally, a polymerization inhibitor, an antioxidant, an ultraviolet absorber, a light stabilizer, a coloring material, metal oxide particles, or the like can be added to the liquid crystal composition in a range where optical performance and the like do not deteriorate.

In a case where the cholesteric liquid crystal layer is formed, it is preferable that the liquid crystal composition is used as liquid. the R reflection cholesteric liquid crystal layer 26R, the G reflection cholesteric liquid crystal layer 26G, and the B reflection cholesteric liquid crystal layer 26B will also be collectively referred to as “cholesteric liquid crystal layer”.

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. Among these organic solvents, one kind may be used alone, or two or more kinds may be used in combination. Among these, a ketone is preferable in consideration of an environmental burden.

In a case where the cholesteric liquid crystal layer is formed, it is preferable that the cholesteric liquid crystal layer is formed by applying the liquid crystal composition to a surface where the cholesteric liquid crystal layer is to be formed, aligning the liquid crystal compound to a state of a cholesteric liquid crystalline phase, and curing the liquid crystal compound.

That is, in a case where the cholesteric liquid crystal layer is formed on the alignment film, it is preferable that the cholesteric liquid crystal layer obtained by immobilizing a cholesteric liquid cholesteric liquid crystalline phase is formed by applying the liquid crystal composition to the alignment film, aligning the liquid crystal compound to a state of a cholesteric liquid crystalline phase, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the cholesteric liquid crystal layer. In the drying and/or heating step, the liquid crystal compound in the liquid crystal composition only has to be aligned to a cholesteric liquid crystalline phase. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

The thickness of the cholesteric liquid crystal layer is not particularly limited, and the thickness with which a required light reflectivity can be obtained may be appropriately set depending on the use of the optical element 10, the light reflectivity required for the cholesteric liquid crystal layer, the material for forming the cholesteric liquid crystal layer, and the like.

<<Liquid Crystal Alignment Pattern of Cholesteric Liquid Crystal Layer>>

In the optical element 10 according to the embodiment of the present invention, the cholesteric liquid crystal layer has the liquid crystal alignment pattern in which the direction of the optical axis 30A derived from the liquid crystal compound 30 forming the cholesteric liquid crystalline phase changes while continuously rotating in the in-plane direction of the cholesteric liquid crystal layer. This point is also applicable to an R reflection cholesteric liquid crystal layer 26R and a B reflection cholesteric liquid crystal layer 26B.

The optical axis 30A derived from the liquid crystal compound 30 is an axis having the highest refractive index in the liquid crystal compound 30, that is, a so-called slow axis. For example, in a case where the liquid crystal compound 30 is a rod-shaped liquid crystal compound, the optical axis 30A is along a rod-shaped major axis direction. In the following description, the optical axis 30A derived from the liquid crystal compound 30 will also be referred to as “the optical axis 30A of the liquid crystal compound 30” or “the optical axis 30A”.

FIG. 3 conceptually shows a plan view of the G reflection cholesteric liquid crystal layer 26G.

The plan view is a view in a case where the optical element 10 is seen from the top in FIG. 1, that is, a view in a case where the optical element 10 is seen from a thickness direction. That is, the thickness direction of the optical element 10 is a laminating direction of the respective layers (films) in the optical element 10.

In addition, in FIG. 3, in order to clarify the configuration of the optical element 10 according to the embodiment of the present invention, only the liquid crystal compound 30 on the surface of the G alignment film 24G is shown as in FIG. 1.

FIG. 3 shows the G reflection cholesteric liquid crystal layer 26G as a representative example. However, basically, the R reflection cholesteric liquid crystal layer 26R and the B reflection cholesteric liquid crystal layer 26B also have the same configuration and the same effects as those of the R reflection cholesteric liquid crystal layer 26R, the lengths A of the single period of the liquid crystal alignment patterns described below are different from each other.

As shown in FIG. 3, on the surface of the G alignment film 24G, the liquid crystal compound 30 forming the G reflection cholesteric liquid crystal layer 26G is two-dimensionally arranged according to the alignment pattern formed on the G alignment film 24G as the lower layer in a predetermined in-plane direction indicated by arrow X and a direction perpendicular to the in-plane direction (arrow X direction).

In the following description, the direction perpendicular to the arrow X direction will be referred to as “Y direction” for convenience of description. That is, in FIGS. 1 and 2 and FIG. 4 described below, the Y direction is a direction perpendicular to the paper plane.

In addition, the liquid crystal compound 30 forming the G reflection cholesteric liquid crystal layer 26G has the liquid crystal alignment pattern in which the direction of the optical axis 30A changes while continuously rotating in the arrow X direction in a plane of the G reflection cholesteric liquid crystal layer 26G. In the example shown in the drawing, the liquid crystal compound 30 has the liquid crystal alignment pattern in which the optical axis 30A of the liquid crystal compound 30 changes while continuously rotating clockwise in the arrow X direction.

Specifically, “the direction of the optical axis 30A of the liquid crystal compound 30 changes while continuously rotating in the arrow X direction (the predetermined in-plane direction)” represents that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or θ−180° in the arrow X direction.

A difference between the angles of the optical axes 30A of the liquid crystal compound 30 adjacent to each other in the arrow X direction is preferably 45° or less, more preferably 15° or less, and still more preferably less than 15°.

On the other hand, in the liquid crystal compound 30 forming the G reflection cholesteric liquid crystal layer 26G, the directions of the optical axes 30A are the same in the Y direction perpendicular to the arrow X direction, that is, the Y direction perpendicular to the in-plane direction in which the optical axis 30A continuously rotates.

In other words, in the liquid crystal compound 30 forming the G reflection cholesteric liquid crystal layer 26G, angles between the optical axes 30A of the liquid crystal compound 30 and the arrow X direction are the same in the Y direction.

In the optical element 10 according to the embodiment of the present invention, in the liquid crystal alignment pattern of the liquid crystal compound 30, the length (distance) over which the optical axis 30A of the liquid crystal compound 30 rotates by 180° in the arrow X direction in which the optical axis 30A changes while continuously rotating is the length Λ (Λ_{G}) of the single period in the liquid crystal alignment pattern.

That is, a distance between centers of two liquid crystal compounds 30 in the arrow X direction is the length Λ of the single period, the two liquid crystal compounds having the same angle in the arrow X direction. Specifically, as shown in FIG. 3, a distance of centers in the arrow X direction of two liquid crystal compounds 30 in which the arrow X direction and the direction of the optical axis 30A match each other is the length Λ of the single period.

In the following description, the length Λ of the single period will also be referred to as “single period Λ”. Since FIG. 3 shows the single period Λ of the G reflection cholesteric liquid crystal layer 26G, the single period Λ is represented by “Λ_{G}”.

In the optical element 10 according to the embodiment of the present invention, in the liquid crystal alignment pattern of the cholesteric liquid crystal layer, the single period Λ is repeated in the arrow X direction, that is, in the in-plane direction in which the direction of the optical axis 30A changes while continuously rotating.

The G reflection cholesteric liquid crystal layer 26G has the liquid crystal alignment pattern in which the optical axis 30A changes while continuously rotating in the arrow X direction in a plane (the predetermined in-plane direction).

The cholesteric liquid crystal layer obtained by immobilizing a cholesteric liquid crystalline phase typically reflects incident light (circularly polarized light) by specular reflection.

On the other hand, the G reflection cholesteric liquid crystal layer 26G having the above-described liquid crystal alignment pattern reflects incidence light in a direction having an angle in the arrow X direction with respect to specular reflection. For example, in the G reflection cholesteric liquid crystal layer 26G, light incident from the normal direction is reflected in a state where it is tilted as indicated by the arrow X with respect to the normal direction instead of being reflected in the normal direction. That is, the light incident from the normal direction refers to light incident from the front side that is light incident to be perpendicular to a main surface. The main surface refers to the maximum surface of a sheet-shaped material.

Hereinafter, the description will be made with reference to FIG. 4.

As described above, the G reflection cholesteric liquid crystal layer 26G selectively reflects right circularly polarized light G_{R} of green light.

Accordingly, in a case where light is incident into the first G reflecting layer 14a or the second G reflecting layer 14b, the G reflection cholesteric liquid crystal layer 26G reflects only right circularly polarized light G_{R} of green light and allows transmission of the other light.

In a case where the right circularly polarized light G_{R} of green light incident into the G reflection cholesteric liquid crystal layer 26G is reflected from the G reflection cholesteric liquid crystal layer 26G, the absolute phase changes depending on the directions of the optical axes 30A of the respective liquid crystal compounds 30.

Here, in the G reflection cholesteric liquid crystal layer 26G, the optical axis 30A of the liquid crystal compound 30 changes while rotating in the arrow X direction (the in-plane direction). Therefore, the amount of change in the absolute phase of the incident right circularly polarized light G_{R} of green light varies depending on the directions of the optical axes 30A.

Further, the liquid crystal alignment pattern formed in the G reflection cholesteric liquid crystal layer 26G is a pattern that is periodic in the arrow X direction. Therefore, as conceptually shown in FIG. 4, an absolute phase Q that is periodic in the arrow X direction corresponding to the direction of the optical axis 30A is assigned to the right circularly polarized light G_{R} of green light incident into the G reflection cholesteric liquid crystal layer 26G.

In addition, the direction of the optical axis 30A of the liquid crystal compound 30 with respect to the arrow X direction is uniform in the arrangement of the liquid crystal compound 30 in the Y direction perpendicular to arrow X direction.

As a result, in the G reflection cholesteric liquid crystal layer 26G, an equiphase surface E that is tilted in the arrow X direction with respect to an XY plane is formed for the right circularly polarized light G_{R} of green light.

Therefore, the right circularly polarized light G_{R} of green light is reflected in the normal direction of the equiphase surface E, and the reflected right circularly polarized light G_{R} of green light is reflected in a direction that is tilted in the arrow X direction with respect to the XY plane. The normal direction of the equiphase surface E is a direction perpendicular to the equiphase surface E. In addition, the XY plane is a main surface of the G reflection cholesteric liquid crystal layer 26G.

Here, a reflection angle of light from the cholesteric liquid crystal layer in which the optical axis 30A of the liquid crystal compound 30 continuously rotates in the in-plane direction (arrow X direction) varies depending on wavelengths of light to be reflected. Specifically, as the wavelength of light increases, the angle of reflected light with respect to incidence light increases.

On the other hand, a reflection angle of light from the cholesteric liquid crystal layer in which the optical axis 30A of the liquid crystal compound 30 continuously rotates in the arrow X direction (in-plane direction) varies depending on the length Λ of the single period of the liquid crystal alignment pattern over which the optical axis 30A rotates by 180° in the arrow X direction, that is, depending on the single period Λ. Specifically, as the length of the single period Λ decreases, the angle of reflected light with respect to incidence light increases.

This point will be described below.

In the optical element 10 according to the embodiment of the present invention, the single period Λ in the alignment pattern of the cholesteric liquid crystal layer is not particularly limited and may be appropriately set depending on the use of the optical element 10 and the like.

Here, the optical element 10 according to the embodiment of the present invention can be suitably used as, for example, a diffraction element that reflects light displayed by a display to be guided to a light guide plate in AR glasses or a diffraction element that emits light propagated in a light guide plate to an observation position by a user from the light guide plate. Regarding this point, the same can also be applied to an optical element 50 or the like described below.

At this time, in order to totally reflect light from the light guide plate, it is necessary to reflect light to be guided to the light guide plate at a large angle to some degree with respect to incidence light. In addition, in order to reliably emit light propagated in the light guide plate, it is necessary to reflect at a large angle to some degree with respect to incidence light.

In addition, as described above, the reflection angle from the cholesteric liquid crystal layer with respect to incidence light can be increased by reducing the single period Λ in the liquid crystal alignment pattern.

In consideration of this point, the single period Λ in the liquid crystal alignment pattern of the cholesteric liquid crystal layer is preferably 50 μm or less and more preferably 10 μm or less.

In consideration of the accuracy of the liquid crystal alignment pattern and the like, the single period Λ in the liquid crystal alignment pattern of the cholesteric liquid crystal layer is preferably 0.1 μm or more.

In the optical element according to the embodiment of the present invention, the cholesteric liquid crystal layer has the liquid crystal alignment pattern in which the direction of the optical axis 30A derived from the liquid crystal compound 30 forming the cholesteric liquid crystalline phase changes while continuously rotating in the in-plane direction of the cholesteric liquid crystal layer.

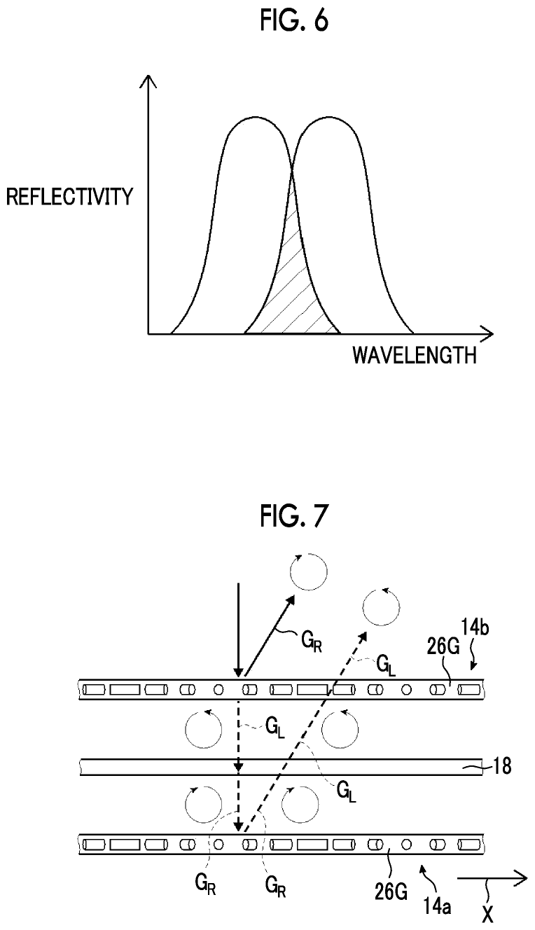

In addition, in the optical element according to the embodiment of the present invention includes at least one combination of two cholesteric liquid crystal layers having the same turning direction of circularly polarized light to be reflected and including an overlapping portion (indicated by a hatched area) in at least a part of selective reflection wavelength ranges as conceptually shown in FIG. 6. Whether or not an overlapping portion is present in at least a part of selective reflection wavelength ranges can be verified by measuring a wavelength distribution of reflected light.

Further, it is preferable that the cholesteric liquid crystal layers forming the combination of the cholesteric liquid crystal layers has the same single period Λ over which the optical axis 30A rotates by 180°, the same rotation direction of the optical axis 30A of the liquid crystal compound 30 in the liquid crystal alignment pattern of the cholesteric liquid crystal layer, and the same direction in which the optical axis 30A continuously changes while rotating.

In the optical element 10 shown in the drawing, the G reflection cholesteric liquid crystal layer 26G of the first G reflecting layer 14a and the G reflection cholesteric liquid crystal layer 26G of the second G reflecting layer 14b form the combination of two cholesteric liquid crystal layers having the same turning direction of circularly polarized light to be reflected and including an overlapping portion in at least a part of selective reflection wavelength ranges, that is, form the reflecting layer pair according to the embodiment of the present invention.

Here, in a preferable aspect of the optical element 10 in the example shown in the drawing, the first G reflecting layer 14a and the second G reflecting layer 14b are the same. Accordingly, the optical element 10 includes the same G reflection cholesteric liquid crystal layer 26G.

That is, the first G reflecting layer 14a and the second G reflecting layer 14b of the optical element 10 are two reflecting layers that formed of the same material under the same forming conditions (work conditions). Alternatively, the first G reflecting layer 14a and the second G reflecting layer 14b of the optical element 10 may be prepared by forming a G alignment film and a G reflection cholesteric liquid crystal layer on a support to prepare one large sheet-shaped material and cutting two sheets having a desired size from the sheet-shaped material.

The optical element 10 is formed by laminating the first G reflecting layer 14a and the second G reflecting layer 14b in a state where directions in which the optical axes 30A of the liquid crystal compounds 30 in the liquid crystal alignment patterns continuously change match each other.

Accordingly, in the G reflection cholesteric liquid crystal layers 26G of the first G reflecting layer 14a and the second G reflecting layer 14b, turning directions of circularly polarized light to be reflected are the same (right circularly polarized light), and selective reflection wavelength ranges completely overlap each other. Further, single periods A over which the optical axes 30A in the liquid crystal alignment patterns rotate by 180° completely match each other, directions (X direction) in which the optical axes 30A of the liquid crystal compounds 30 in the liquid crystal alignment patterns continuously change are the same, and rotation directions of the optical axes 30A are also the same (clockwise).

With the above-described configuration, a direction in which green light is reflected from the first G reflecting layer 14a and a direction in which green light is reflected from the second G reflecting layer 14b can be made suitably match each other, and the amount of light reflected in a desired direction can be suitably improved.

However, the optical element according to the embodiment of the present invention is not limited to this configuration as long as it includes one (one or more) combination of cholesteric liquid crystal layers having the same turning direction of circularly polarized light to be reflected and including an overlapping portion in selective reflection wavelength ranges.

In the following description, “the combination of cholesteric liquid crystal layers having the same turning direction of circularly polarized light to be reflected and including an overlapping portion in selective reflection wavelength ranges”, that is, the reflecting layer pair according to the embodiment of the present invention will also be referred to as “the combination of the cholesteric liquid crystal layers”.

That is, in the optical element according to the embodiment of the present invention, even in a case where the selective reflection wavelength ranges of the two cholesteric liquid crystal layers forming the combination of the cholesteric liquid crystal layer do not completely match each other, as long as at least a part of the selective reflection wavelength ranges includes an overlapping portion, light having a wavelength in the overlapping range (hatched area) can be reflected in a large amount of light.

Here, from the viewpoint of the amount of light reflected in the optical element, it is preferable that the cholesteric liquid crystal layers forming the combination of the cholesteric liquid crystal layers includes a wide overlapping range in the selective reflection wavelength ranges. Specifically, in a case where a range between two wavelengths of a half value transmittance of the cholesteric liquid crystal layers forming the combination of the cholesteric liquid crystal layers is represented by Δλₕ, a difference between selective reflection center wavelengths is preferably 0.8×Δλₕ nm or less, more preferably 0.6×Δλₕ nm or less, and still more preferably 0.4×Δλₕ nm or less. In particular, it is preferable that the selective reflection center wavelengths match each other, and it is more preferable that, as in the G reflection cholesteric liquid crystal layer 26G in the example shown in the drawing, the cholesteric liquid crystal layers are cholesteric liquid crystal layers having the same selective reflection wavelength range.

In a case where ranges between two wavelengths of a half value transmittance of the two cholesteric liquid crystal layers are different, the average value thereof is used as Δλₕ.

In addition, in the optical element according to the embodiment of the present invention, it is preferable that the cholesteric liquid crystal layers forming the combination of the cholesteric liquid crystal layers have the same single period Λ. In the present invention, the lengths of the single periods Λ in the liquid crystal alignment patterns being the same represents that the difference between the lengths of the single periods Λ is 30% or lower.

Here, in the cholesteric liquid crystal layers forming the combination of the cholesteric liquid crystal layers, it is preferable that the difference between the lengths of the single periods Λ in the liquid crystal alignment patterns is small. As described above, the length of the single period Λ decreases, the reflection angle with respect to incidence light increases. Accordingly, as the difference between the lengths of the single periods Λ decreases, directions in which light is reflected from the cholesteric liquid crystal layers forming the combination of the cholesteric liquid crystal layers can be made similar to each other. In the cholesteric liquid crystal layers forming the combination of the cholesteric liquid crystal layers, the difference between the lengths of the single periods Λ in the liquid crystal alignment patterns is preferably 20% or lower and more preferably 10% or lower. It is still more preferable that the single periods Λ match each other as in the G reflection cholesteric liquid crystal layer 26G in the example shown in the drawing.

In the optical element according to the embodiment of the present invention, the cholesteric liquid crystal layers forming the combination of the cholesteric liquid crystal layers may have different directions in which the optical axes 30A of the liquid crystal compounds 30 in the liquid crystal alignment patterns continuously change. For example, the direction in which the optical axis 30A of the G reflection cholesteric liquid crystal layer of the first G reflecting layer continuously changes may be the arrow X direction, and the direction in which the optical axis 30A of the G reflection cholesteric liquid crystal layer of the second G reflecting layer continuously changes may be a direction that is tilted by 10° with respect to the arrow X direction.

However, in the cholesteric liquid crystal layer having the above-described liquid crystal alignment pattern, light is reflected in a state where it is tilted in the direction (or the opposite direction) in which the optical axis 30A of the liquid crystal compound 30 in the liquid crystal alignment pattern continuously changes. Accordingly, in order to make directions in which light is reflected from the cholesteric liquid crystal layers forming the combination of the cholesteric liquid crystal layers match each other, it is preferable that the cholesteric liquid crystal layers forming the combination of the cholesteric liquid crystal layers has the same direction in which the optical axis 30A of the liquid crystal compound 30 in the liquid crystal alignment pattern continuously changes.

In addition, in the optical element according to the embodiment of the present invention, the cholesteric liquid crystal layers forming the combination of the cholesteric liquid crystal layers may have different rotation directions of the optical axes 30A of the liquid crystal compounds 30 in the liquid crystal alignment patterns. For example, the rotation direction of the optical axis 30A of the G reflection cholesteric liquid crystal layer of the first G reflecting layer may be clockwise, and the rotation direction of the optical axis 30A of the G reflection cholesteric liquid crystal layer of the second G reflecting layer may be counterclockwise.

However, in a case where the rotation directions of the optical axes 30A in the liquid crystal alignment patterns are opposite to each other, the directions in which light is reflected from the cholesteric liquid crystal layers are opposite to each other. Accordingly, in order to make directions in which light is reflected from the cholesteric liquid crystal layers forming the combination of the cholesteric liquid crystal layers match each other, the cholesteric liquid crystal layers forming the combination of the cholesteric liquid crystal layers may have the same rotation direction of the optical axis 30A in the liquid crystal alignment pattern.

The λ/2 plate 18 is provided between the first G reflecting layer 14a and the second G reflecting layer 14b. That is, the λ/2 plate 18 is provided between the two G reflection cholesteric liquid crystal layers 26G forming the combination of the cholesteric liquid crystal layers. In other words, the λ/2 plate 18 is provided between the two G reflection cholesteric liquid crystal layers 26G forming the reflecting layer pair according to the embodiment of the present invention.

The λ/2 plate refers to a plate in which an in-plane retardation Re(λ) at a specific wavelength λ nm satisfies Re(λ)≈λ/2. This expression only has to be satisfied at any wavelength (for example, 550 nm) in a visible range, at any wavelength in an ultraviolet range, or at any wavelength in an infrared range. In addition, in the first G reflecting layer 14a, the second G reflecting layer 14b, and the λ/2 plate 18, it is preferable that the selective reflection center wavelength of the cholesteric liquid crystal layer and the wavelength of the λ/2 plate 18 at which Re(λ)=λ/2 match each other.

As described above, the λ/2 plate 18 may include the same support as the support 20. In this case, a combination of the λ/2 plate 18 and the support is the λ/2 plate.

In the λ/2 plate 18, an in-plane retardation value Re (550) at a wavelength of 550 nm is not particularly limited and is preferably 255 to 295 nm, more preferably 260 to 290 nm, and still more preferably 265 to 285 nm. As described above, in a case where the λ/2 plate 18 includes the support or the like, it is preferable that the in-plane retardation as a whole is in the above-described range.

As the λ/2 plate 18, various well-known λ/2 plates can be used.

Examples of the λ/2 plate 18 include a λ/2 plate obtained by polymerization of a polymerizable liquid crystal compound, a λ/2 plate formed of a polymer film, a λ/2 plate obtained by laminating two polymer films, a λ/2 plate having a phase difference of λ/2 as a phase difference layer, and a λ/2 plate that exhibits a phase difference of λ/2 by structural birefringence.

Hereinafter, the optical element according to the embodiment of the present invention will be described in more detail by describing the action of the optical element 10 according to the embodiment of the present invention with reference to FIG. 7.

In FIG. 7, in order to clearly show the action of the optical element 10, only the G reflection cholesteric liquid crystal layer 26G is shown as the first G reflecting layer 14a, and only the G reflection cholesteric liquid crystal layer 26G is shown as the second G reflecting layer 14b. In addition, due to the same reason, in FIG. 7, the first G reflecting layer 14a, the λ/2 plate 18, and the second G reflecting layer 14b are spaced from each other. Further, due to the same reason, light is incident from the normal direction (front side) into the optical element 10.

As described above, the G reflection cholesteric liquid crystal layer 26G selectively reflects right circularly polarized light G_{R} of green light and allows transmission of the other light.

In a case where light is incident into the optical element 10, the G reflection cholesteric liquid crystal layer 26G of the second G reflecting layer 14b reflects only right circularly polarized light G_{R} of green light and allows transmission of the other light.

Here, as described above, the G reflection cholesteric liquid crystal layer 26G has the liquid crystal alignment pattern in which the optical axis 30A derived from the liquid crystal compound 30 changes while continuously rotating clockwise in the arrow X direction. Accordingly, the right circularly polarized light G_{R} of green light is reflected in a state where it is tilted in the arrow X direction with respect to the normal direction instead of being reflected in the normal direction.

Next, the light transmitted through the second G reflecting layer 14b is incident into the λ/2 plate 18.

The circularly polarized light incident into and transmitted through the λ/2 plate 18 is converted into circularly polarized light having an opposite turning direction. Accordingly, left circularly polarized light G_{L} of green light transmitted through the second G reflecting layer 14b is converted into right circularly polarized light G_{R} of green light by the λ/2 plate 18.

Next, the light transmitted through the λ/2 plate 18 is incident into the first G reflecting layer 14a. As in the second G reflecting layer 14b, the G reflection cholesteric liquid crystal layer 26G of the first G reflecting layer 14a also selectively reflects right circularly polarized light G_{R} of green light and allows transmission of the other light.

Accordingly, the right circularly polarized light G_{R} of green light is reflected from the G reflection cholesteric liquid crystal layer 26G. Here, the G reflection cholesteric liquid crystal layer 26G of the first G reflecting layer 14a and the G reflection cholesteric liquid crystal layer 26G of the second G reflecting layer 14b are the same. Accordingly, the right circularly polarized light G_{R} of green light reflected from the G reflection cholesteric liquid crystal layer 26G of the first G reflecting layer 14a and the right circularly polarized light G_{R} of green light reflected from the G reflection cholesteric liquid crystal layer 26G of the second G reflecting layer 14b are reflected in the same direction.

Next, the right circularly polarized light G_{R} of green light reflected from the G reflection cholesteric liquid crystal layer 26G of the first G reflecting layer 14a is incident into the λ/2 plate 18. The right circularly polarized light G_{R} of green light incident into and transmitted through the λ/2 plate 18 is converted into left circularly polarized light GL of green light having an opposite turning direction as described above.

Next, the left circularly polarized light G_{L} of green light transmitted through the λ/2 plate 18 is incident into the second G reflecting layer 14b. As described above, the G reflection cholesteric liquid crystal layer 26G of the second G reflecting layer 14b reflects only right circularly polarized light G_{R} of green light and allows transmission of the other light. Accordingly, the left circularly polarized light G_{L} of green light incident into the second G reflecting layer 14b (the G reflection cholesteric liquid crystal layer 26G) transmits therethrough as it is. As a result, reflected light of the optical element 10 is obtained.

As described above, in the reflective optical element including the cholesteric liquid crystal layer of the related art disclosed in WO2016/194961A, only one of left circularly polarized light or right circularly polarized light is reflected. Therefore, in the reflective optical element including the cholesteric liquid crystal layer of the related art, the amount of light reflected may be insufficient depending on the use.

On the other hand, in the optical element according to the embodiment of the present invention in which at least one combination of two cholesteric liquid crystal layers having the same turning direction of circularly polarized light to be reflected and including an overlapping portion in at least a part of selective reflection wavelength ranges and a λ/2 plate is provided between two cholesteric liquid crystal layers forming the combination of the cholesteric liquid crystal layers, both right circularly polarized light and left circularly polarized light can be reflected. Therefore, the amount of light reflected (reflectivity) in a direction having an angle with respect to specular reflection can be significantly improved as compared to the optical element including the cholesteric liquid crystal layer of the related art.

In addition, preferably, by making the lengths of the single periods Λ of the liquid crystal alignment patterns match each other and making the rotation directions of the optical axes in the liquid crystal alignment patterns and the change directions of the optical axes match each other as in the optical element 10 in the example shown in the drawing, directions in which light is reflected from the cholesteric liquid crystal layers forming the combination of the cholesteric liquid crystal layers can be made match each other. Therefore, a very large amount of light can be reflected in a predetermined direction instead of being reflected by specular reflection.

### Second Embodiment

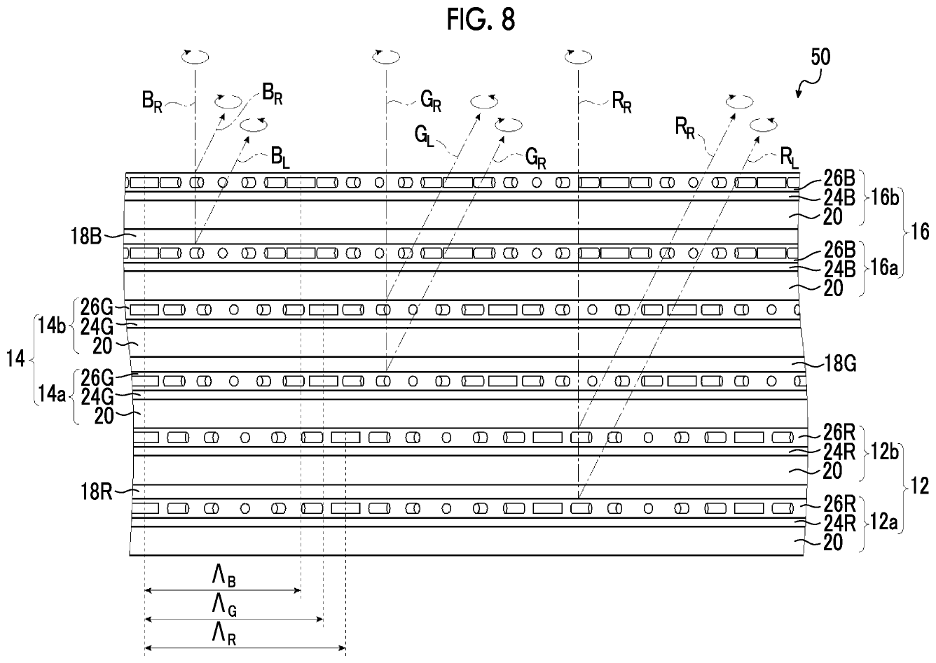

FIG. 8 conceptually shows another example of the optical element according to the embodiment of the present invention.

The optical element 10 shown in FIG. 1 is an optical element that reflects green light and corresponds to a monochrome image or the like. The optical element 50 shown in FIG. 8 is an optical element that reflects red light, green light, and blue light and corresponds to a full color image or the like.

The optical element 50 shown in FIG. 8 includes: an R reflection member 12 that selectively reflects red light; a G reflection member 14 that selectively reflects green light; and a B reflection member 16 that selectively reflects blue light. The respective reflection members are bonded to a bonding layer provided therebetween as in the first G reflecting layer 14a, a λ/2 plate 18G, and the like.

In addition, the R reflection member 12 a first R reflecting layer 12a, a λ/2 plate 18R, and a second R reflecting layer 12b. The G reflection member 14 includes the first G reflecting layer 14a, the λ/2 plate 18G, and the second G reflecting layer 14b. The B reflection member 16 includes a first B reflecting layer 16a, a λ/2 plate 18B, and a second B reflecting layer 16b.

Here, the λ/2 plate 18G of the G reflection member 14 is the same as the λ/2 plate 18. That is, the G reflection member 14 is the same as the optical element 10.

The first R reflecting layer 12a and the second R reflecting layer 12b forming the R reflection member 12 includes the support 20, the R alignment film 24R, and the R reflection cholesteric liquid crystal layer 26R. In the R reflection member 12, the R reflection cholesteric liquid crystal layer 26R of the first R reflecting layer 12a and the R reflection cholesteric liquid crystal layer 26R of the second R reflecting layer 12b form the combination of two cholesteric liquid crystal layers having the same turning direction of circularly polarized light to be reflected and including an overlapping portion in at least a part of selective reflection wavelength ranges, that is, form the reflecting layer pair according to the embodiment of the present invention.

The first G reflecting layer 14a and the second G reflecting layer 14b forming the G reflection member 14 includes the support 20, the G alignment film 24G, and the G reflection cholesteric liquid crystal layer 26G as in the above-described optical element 10.

The first B reflecting layer 16a and the second B reflecting layer 16b forming the B reflection member 16 includes the support 20, the B alignment film 24B, and the B reflection cholesteric liquid crystal layer 26B. In the B reflection member 16, the B reflection cholesteric liquid crystal layer 26B of the first B reflecting layer 16a and the B reflection cholesteric liquid crystal layer 26B of the second B reflecting layer 16b form the combination of two cholesteric liquid crystal layers having the same turning direction of circularly polarized light to be reflected and including an overlapping portion in at least a part of selective reflection wavelength ranges, that is, form the reflecting layer pair according to the embodiment of the present invention.

As described above, the optical element 50 shown in FIG. 8 reflects red light, green light, and blue light. Accordingly, the cholesteric liquid crystal layer forming the combination of the cholesteric liquid crystal layers in the R reflection member 12, the cholesteric liquid crystal layer forming the combination of the cholesteric liquid crystal layers in the G reflection member 14, and the cholesteric liquid crystal layer forming the combination of the cholesteric liquid crystal layers in the B reflection member 16 have different selective reflection center wavelengths of the cholesteric liquid crystal layers.

That is, the combination of the cholesteric liquid crystal layers forming the R reflection member 12, the combination of the cholesteric liquid crystal layers forming the G reflection member 14, and the combination of the cholesteric liquid crystal layers forming the B reflection member 16 have different overlapping portions in selective reflection wavelength ranges.

In other words, the optical element 50 shown in FIG. 8 has a configuration in which three optical elements according to the embodiment of the present invention having different selective reflection center wavelengths of the cholesteric liquid crystal layers forming the combination of the cholesteric liquid crystal layers are laminated.

As in the first G reflecting layer 14a and the second G reflecting layer 14b forming the G reflection member 14, in a preferable aspect, the first R reflecting layer 12a and the second R reflecting layer 12b forming the R reflection member 12 and the first B reflecting layer 16a and the second B reflecting layer 16b forming the B reflection member 16 are the same.

Accordingly, regarding the first R reflecting layer 12a and the second R reflecting layer 12b forming the R reflection member 12 and the first B reflecting layer 16a and the second B reflecting layer 16b forming the B reflection member 16, in each combination of the cholesteric reflecting layers, turning directions of circularly polarized light to be reflected are the same (right circularly polarized light), and selective reflection wavelength ranges completely overlap each other.

In addition, as in the first G reflecting layer 14a and the second G reflecting layer 14b forming the optical element 10, regarding the first R reflecting layer 12a and the second R reflecting layer 12b forming the R reflection member 12 and the first B reflecting layer 16a and the second B reflecting layer 16b forming the B reflection member 16, each of the reflecting layers is by laminating the first and second reflecting layers in a state where directions in which the optical axes 30A of the liquid crystal compounds 30 in the liquid crystal alignment patterns continuously change match each other.

Accordingly, regarding the first R reflecting layer 12a and the second R reflecting layer 12b forming the R reflection member 12 and the first B reflecting layer 16a and the second B reflecting layer 16b forming the B reflection member 16, in each combination of the cholesteric reflecting layers, single periods Λ over which the optical axes 30A in the liquid crystal alignment patterns rotate by 180° completely match each other, directions (X direction) in which the optical axes 30A of the liquid crystal compounds 30 in the liquid crystal alignment patterns continuously change are the same, and rotation directions of the optical axes 30A are also the same (clockwise).

In the optical element according to the embodiment of the present invention, the combination of the cholesteric liquid crystal layers forming each of the reflecting layers is not limited to this configuration. As in the optical element 10, single periods Λ and the like of the cholesteric liquid crystal layers forming the combination of the cholesteric liquid crystal layers may be different from each other.

In the R reflection member 12 and the B reflection member 16, the support 20 is the same as the support 20 of the optical element 10.

In addition, in the R reflection member 12 and the B reflection member 16, the R alignment film 24R and the B alignment film 24B are basically the same as the G alignment film 24G.

That is, the R alignment film 24R is an alignment film for aligning the liquid crystal compound 30 to a predetermined liquid crystal alignment pattern during the formation of the R reflection cholesteric liquid crystal layer 26R of the R reflection member 12. In addition, the B alignment film 24B is an alignment film for aligning the liquid crystal compound 30 to a predetermined liquid crystal alignment pattern during the formation of the B reflection cholesteric liquid crystal layer 26B of the B reflection member 16.

Here, although described in detail below, in a preferable aspect of the optical element 50, single periods Λ that are lengths over which the directions of the optical axes 30A in the liquid crystal alignment patterns of the cholesteric liquid crystal layers rotate by 180° vary between the R reflection member 12, the G reflection member 14, and the B reflection member 16.

In addition, in a more preferable aspect of the optical element 50, a permutation of lengths of selective reflection center wavelengths and a permutation of lengths of the single periods Λ in the cholesteric liquid crystal layers forming each of the reflecting layers match each other in the R reflection member 12, the G reflection member 14, and the B reflection member 16.

In the optical element 50, the lengths of selective reflection center wavelengths in the cholesteric liquid crystal layers forming each of the reflecting layers of each of the reflection members satisfy “R reflection member 12>G reflection member 14>B reflection member 16”. Therefore, the lengths of the single periods Λ of the liquid crystal alignment patterns in the cholesteric liquid crystal layers forming each of the reflecting layers satisfy “R reflection member 12>G reflection member 14>B reflection member 16”.

Accordingly, the alignment film of each of the reflecting layers is formed such that each of the cholesteric liquid crystal layers can form the liquid crystal alignment pattern.

The R reflection cholesteric liquid crystal layer 26 of the R reflection member 12 reflects right circularly polarized light R_{R} of red light and allows transmission of the other light. Therefore, the R reflection cholesteric liquid crystal layer 26 has a selective reflection center wavelength in a red light wavelength range.

The B reflection cholesteric liquid crystal layer 26B of the B reflection member 16 reflects right circularly polarized light B_{R} of blue light and allows transmission of the other light. Therefore, the B reflection cholesteric liquid crystal layer 26B has a selective reflection center wavelength in a blue light wavelength range.

As in the G reflection cholesteric liquid crystal layer 26G, the R reflection cholesteric liquid crystal layer 26R and the B reflection cholesteric liquid crystal layer 26B are obtained by immobilizing a cholesteric liquid crystalline phase. That is, the R reflection cholesteric liquid crystal layer 26R and the B reflection cholesteric liquid crystal layer 26B are formed of the liquid crystal compound 30 having a cholesteric structure.

In the R reflection member 12 and the B reflection member 16, the R reflection cholesteric liquid crystal layer 26 and the B reflection cholesteric liquid crystal layer 26B basically have the same configuration as the G reflection cholesteric liquid crystal layer 26G, except that the selective reflection center wavelengths and the single periods Λ of the liquid crystal alignment patterns are different from each other.

A typical cholesteric liquid crystal layer reflects incident light by specular reflection.

On the other hand, as in the G reflection cholesteric liquid crystal layer 26G, the R reflection cholesteric liquid crystal layer 26R and the B reflection cholesteric liquid crystal layer 26B have a liquid crystal alignment pattern in which the optical axis 30A changes while continuously rotating in an in-plane direction.

As described above, the cholesteric liquid crystal layer having the liquid crystal alignment pattern reflects incident light in a state where it is tilted in the arrow X direction in which the optical axis 30a changes while continuously rotating with respect to specular reflection. For example, light incident from the normal direction (front side) is reflected in a state where it is tilted in the arrow X direction with respect to the normal direction instead of being reflected in the normal direction.

Here, a reflection angle of light from the cholesteric liquid crystal layer in which the optical axis 30A of the liquid crystal compound 30 continuously rotates in the in-plane direction (arrow X direction) varies depending on wavelengths of light to be reflected. Specifically, as the wavelength of light increases, the angle of reflected light with respect to incidence light increases.

Accordingly, in a case where red light, green light, and blue light are reflected as in the optical element shown in FIG. 8, the reflection angles of red light, green light, and blue light are different from each other. Specifically, in a case where cholesteric reflecting layers having the same single period Λ of the liquid crystal alignment pattern and having reflection center wavelengths in red, green, blue light ranges are compared to each other, regarding the angle of reflected light with respect to incidence light, the angle of red light is the largest, the angle of green light is the second largest, and the angle of blue light is the smallest.

Therefore, for example, in a light guide plate of AR glasses, in a case where a reflection element that are formed of cholesteric liquid crystal layers having the same single period Λ of the liquid crystal alignment pattern and different reflection center wavelengths is used as a diffraction element for incidence and emission of light into and from the light guide plate, in the case of a full color image, an image having a so-called color shift in which reflection directions of red light, green light, and blue light are different from each other and a red image, a green image, and a blue image do not match each other is observed.

In addition, a reflection angle of light from the cholesteric liquid crystal layer in which the optical axis 30A of the liquid crystal compound 30 continuously rotates in the arrow X direction (in-plane direction) varies depending on the length Λ of the single period of the liquid crystal alignment pattern over which the optical axis 30A rotates by 180° in the arrow X direction, that is, depending on the single period Λ (refer to FIG. 3). Specifically, as the length of the single period Λ decreases, the angle of reflected light with respect to incidence light increases.

In the following description, in order to distinguish between the single periods Λ of the respective cholesteric liquid crystal layers, the single period Λ in the R reflection cholesteric liquid crystal layer 26R will also be referred to as “Λ_{R}”, the single period Λ in the G reflection cholesteric liquid crystal layer 26G will also be referred to as “Λ_{G}”, and the single period Λ in the B reflection cholesteric liquid crystal layer 26B will also be referred to as “Λ_{B}”.

Correspondingly, in the optical element 50 shown in FIG. 8, a permutation of the selective reflection center wavelengths and a permutation of the single periods Λ in the cholesteric liquid crystal layers forming each of the reflecting layers match each other.

That is, in a case where the selective reflection center wavelength of the R reflection cholesteric liquid crystal layer 26R is represented by λ_{R}, the selective reflection center wavelength of the G reflection cholesteric liquid crystal layer 26G is represented by λ_{G}, and the selective reflection center wavelength of the B reflection cholesteric liquid crystal layer 26B is represented by λ_{B}, in the optical element 10 shown in the drawing, the selective reflection center wavelengths satisfy “λ_{R}>λ_{G}>λ_{B}”. Therefore, the single periods Λ of the liquid crystal alignment patterns of the respective cholesteric liquid crystal layers satisfy “single period ΛR>single period ΛG>single period ΛB” as shown in FIG. 1.

In the optical element according to the embodiment of the present invention, in the combination of the cholesteric liquid crystal layers forming each of the reflecting layers, the selective reflection center wavelengths and/or the single periods Λ in the cholesteric liquid crystal layers forming the combination may be different.

In this case, in all the cholesteric liquid crystal layers forming the optical element, it is preferable that a permutation of the selective reflection center wavelengths and a permutation of the single periods Λ in the cholesteric liquid crystal layers forming each of the reflecting layers match each other, and it is more preferable that the following conditions are satisfied.

As described above, as the wavelength of light increases, the reflection angle with respect to an incidence direction of light into the cholesteric liquid crystal layer in which the optical axis 30A of the liquid crystal compound 30 rotates increases. On the other hand, as the length of the single period Λ decreases, the reflection angle with respect to an incidence direction of light into the cholesteric liquid crystal layer in which the optical axis 30A of the liquid crystal compound 30 rotates increases.

Accordingly, in the optical element 50 shown in FIG. 8 in which a permutation of lengths of the selective reflection center wavelengths and a permutation of lengths of the single periods Λ match each other in the plurality of reflecting layers including cholesteric liquid crystal layers having different selective reflection center wavelengths, the wavelength dependence of the reflection angle of light is significantly reduced, and light components having different wavelengths can be reflected substantially in the same direction. Therefore, by using the optical element 50 as a member for incidence and emission into and from a light guide plate, for example, in AR glasses, a red image, a green image, and a blue image can be propagated by one light guide plate without the occurrence of a color shift. As a result, an appropriate image can be displayed to a user.

Further, in the optical element according to the embodiment of the present invention, light is reflected by the cholesteric liquid crystal layer. Therefore, by adjusting the single period Λ in the liquid crystal alignment pattern, the reflection angle of light can be adjusted with a high degree of freedom.

As described above, in the optical element 50 according to the embodiment of the present invention, it is preferable that a permutation of the selective reflection center wavelength of the cholesteric liquid crystal layer and a permutation of the single period Λ of the liquid crystal alignment pattern match each other in a plurality of cholesteric liquid crystal layers having different selective reflection center wavelengths.

Here, in a case where the optical element 50 is seen from one surface in the laminating direction of the R reflection member 12, the G reflection member 14, and the B reflection member 16,

a selective reflection center wavelength of a cholesteric liquid crystal layer forming a first reflecting layer is represented by λ₁;

a selective reflection center wavelength of a cholesteric liquid crystal layer forming an n-th (n represents an integer of 2 or more) reflecting layer is represented by λₙ;

a single period Λ in a liquid crystal alignment pattern of the cholesteric liquid crystal layer forming the first reflecting layer is represented by λ₁; and

a single period Λ in a liquid crystal alignment pattern of the cholesteric liquid crystal layer forming the n-th reflecting layer is represented by λₙ.

In this case, it is preferable that the following Expression (1) is satisfied.

0.8×[(λₙ/λ₁)Λ₁]≤Λ_{n⋅}≤1.2×[(λₙ/λ₁)Λ₁] Expression (1)

In addition, it is more preferable that the optical element according to the embodiment of the present invention satisfies the following Expression (2).

0.9×[(λₙ/λ₁)λ₁]≤λ_{n⋅}≤1.1×[(λₙ/λ₁)Λ₁] Expression (2)

Further, it is still more preferable that the optical element according to the embodiment of the present invention satisfies the following Expression (3).

0.95×[(λₙ/λ₁)Λ₁]≤Λ_{n⋅}≤1.05×[(λₙ/λ₁)Λ₁] Expression (3)

By adjusting the selective reflection center wavelengths λ and the single periods Λ of the liquid crystal alignment patterns in the respective cholesteric liquid crystal layers to satisfy the Expression (1), reflection angles of light components having respective wavelengths can be more suitably matched, and the wavelength dependence of the reflection angle of light can be further reduced.

In the optical element 50 in which the reflection members that reflect light of different colors, the laminating order of the reflection members is not limited.

Here, in the present invention, as in the optical element 50 in FIG. 8, it is preferable that the respective reflecting layers are laminated such that the lengths of the selective reflection center wavelengths of the cholesteric liquid crystal layers forming the reflection members sequentially increase toward the laminating direction of the reflection members.

In the reflection of light from the cholesteric liquid crystal layer, a so-called blue shift (short-wavelength shift) in which the wavelength of light to be selectively reflected shifts to a short wavelength side occurs depending on angles of incidence light. On the other hand, by laminating the cholesteric liquid crystal layers that reflect light of different colors in the order of selective reflection center wavelengths of the cholesteric liquid crystal layers forming the reflection members, a side where the selective reflection center wavelength is short is set as a light incidence side such that the influence of the blue shift can be reduced.

In the R reflection member 12, the λ/2 plate 18R is provided between the first R reflecting layer 12a and the second R reflecting layer 12b. That is, the λ/2 plate 18R is provided between the two R reflection cholesteric liquid crystal layers 26R forming the combination of the cholesteric liquid crystal layers.

In the B reflection member 16, the λ/2 plate 18B is provided between the first B reflecting layer 16a and the second B reflecting layer 16b. That is, the λ/2 plate 18B is provided between the two B reflection cholesteric liquid crystal layers 26B forming the combination of the cholesteric liquid crystal layers.

The λ/2 plate 18R and the λ/2 plate 18B are the same as the λ/2 plate 18 (λ/2 plate 18G), which is a plate in which an in-plane retardation Re(λ) at a specific wavelength λ nm satisfies Re(λ)≈λ/2.

The λ/2 plate 18R and the λ/2 plate 18B may be the same as the λ/2 plate 18. That is, in-plane retardations Re(550) of the λ/2 plate 18R and the λ/2 plate 18B at a wavelength of 550 nm may satisfy Re(550)=λ/2.

It is preferable that an in-plane retardation Re(635) of the λ/2 plate 18R at a wavelength of 635 nm satisfies Re(635)=λ/2. The in-plane retardation Re(635) of the λ/2 plate 18R at a wavelength of 635 nm is not particularly limited and is preferably 297 to 338 nm, more preferably 302 to 333 nm and still more preferably 307 to 328 nm.

In addition, it is preferable that an in-plane retardation Re(450) of the λ/2 plate 18B at a wavelength of 450 nm satisfies Re(450)=λ/2. The in-plane retardation Re(450) of the λ/2 plate 18B at a wavelength of 450 nm is not particularly limited and is preferably 205 to 245 nm, more preferably 210 to 240 nm and still more preferably 215 to 235 nm.

Hereinafter, the effects of the optical element 50 will be described.

Basically, the optical element 50 shown in FIG. 8 has the same effects as those of the optical element 10, that is, the G reflection member 14, except that the R reflection member 12 and the B reflection member 16 have different wavelength ranges of light to be selectively reflected.

In a case where light is incident into the optical element 50, the B reflection cholesteric liquid crystal layer 26B of the second B reflecting layer 16b of the B reflection member 16 reflects only right circularly polarized light B_{R} of blue light and allows transmission of the other light. The B reflection cholesteric liquid crystal layer 26B has the liquid crystal alignment pattern in which the optical axis 30A derived from the liquid crystal compound 30 changes while continuously rotating clockwise in the arrow X direction. Accordingly, the right circularly polarized light B_{R} of blue light is reflected in a state where it is tilted in the arrow X direction with respect to the normal direction instead of being reflected in the normal direction.

Next, the light transmitted through the second G reflecting layer 14b is incident into the λ/2 plate 18B.

The circularly polarized light incident into and transmitted through the λ/2 plate 18B is converted into circularly polarized light having an opposite turning direction. Accordingly, the left circularly polarized light B_{L} of blue light transmitted through the λ/2 plate 18B is converted into right circularly polarized light B_{R} of blue light.

Next, the light transmitted through the λ/2 plate 18B is incident into the first B reflecting layer 16a of the B reflection member 16. As in the second G reflecting layer 16b, the B reflection cholesteric liquid crystal layer 26B of the first B reflecting layer 16a also selectively reflects the right circularly polarized light B_{R} of blue light and allows transmission of the other light. Here, the B reflection cholesteric liquid crystal layer 26B of the first B reflecting layer 16a and the B reflection cholesteric liquid crystal layer 26B of the second B reflecting layer 16b are the same. Accordingly, the right circularly polarized light B_{R} of blue light reflected from the B reflection cholesteric liquid crystal layer 26B of the first B reflecting layer 16a and the right circularly polarized light B_{R} of blue light reflected from the B reflection cholesteric liquid crystal layer 26B of the second B reflecting layer 16b are reflected in the same direction.

Next, the right circularly polarized light B_{R} of blue light reflected from the B reflection cholesteric liquid crystal layer 26B of the first B reflecting layer 16a is incident into and transmitted through the λ/2 plate 18B to be converted into left circularly polarized light B_{L} of blue light, and transmits through the second B reflecting layer 16b. As a result, reflected light of the optical element 50 is obtained.

On the other hand, in the light transmitted through the B reflection member 16, the G reflection cholesteric liquid crystal layer 26G of the second G reflecting layer 14b of the G reflection member 14 reflects only right circularly polarized light G_{R} of green light and allows transmission of the other light.

The G reflection cholesteric liquid crystal layer 26G has the liquid crystal alignment pattern in which the optical axis 30A derived from the liquid crystal compound 30 changes while continuously rotating clockwise in the arrow X direction. Accordingly, the right circularly polarized light G_{R} of green light is reflected in a state where it is tilted in the arrow X direction with respect to the normal direction instead of being reflected in the normal direction.

The right circularly polarized light G_{R} of green light reflected from the G reflection cholesteric liquid crystal layer 26G of the second G reflecting layer 14b is incident into the B reflection member 16, transmits through the first B reflecting layer 16a, is converted into left circularly polarized light G_{L} of green light by the λ/2 plate 18B, and transmits through the second B reflecting layer 16b. As a result, reflected light of the optical element 10 is obtained.

On the other hand, the light transmitted through the second G reflecting layer 14b is incident into the λ/2 plate 18G.

The circularly polarized light incident into and transmitted through the λ/2 plate 18G is converted into circularly polarized light having an opposite turning direction. Accordingly, the left circularly polarized light G_{L} of green light transmitted through the λ/2 plate 18G is converted into right circularly polarized light G_{R} of green light.

Next, the light transmitted through the λ/2 plate 18G is incident into the first G reflecting layer 14a. As in the second G reflecting layer 14b, the G reflection cholesteric liquid crystal layer 26G of the first G reflecting layer 14a also selectively reflects right circularly polarized light G_{R} of green light and allows transmission of the other light.

Accordingly, the right circularly polarized light G_{R} of green light is reflected from the G reflection cholesteric liquid crystal layer 26G. Here, the G reflection cholesteric liquid crystal layer 26G of the first G reflecting layer 14a and the G reflection cholesteric liquid crystal layer 26G of the second G reflecting layer 14b are the same. Accordingly, the right circularly polarized light G_{R} of green light reflected from the G reflection cholesteric liquid crystal layer 26G of the first G reflecting layer 14a and the right circularly polarized light G_{R} of green light reflected from the G reflection cholesteric liquid crystal layer 26G of the second G reflecting layer 14b are reflected in the same direction.

The right circularly polarized light G_{R} of green light reflected from the G reflection cholesteric liquid crystal layer 26G of the first G reflecting layer 14a is incident into and transmits through the λ/2 plate 18G to be converted into left circularly polarized light G_{L} of green light, transmits through the second G reflecting layer 14b, and is incident into the B reflection member 16.

The left circularly polarized light G_{L} of green light incident into the B reflection member 16 transmits through the first B reflecting layer 16a, is converted into right circularly polarized light G_{R} of green light by the λ/2 plate 18B, and transmits through the second B reflecting layer 16b. As a result, reflected light of the optical element 50 is obtained.

On the other hand, in the light transmitted through the G reflection member 14, the R reflection cholesteric liquid crystal layer 26R of the second R reflecting layer 12b of the R reflection member 12 reflects only right circularly polarized light R_{R} of red light and allows transmission of the other light.

The R reflection cholesteric liquid crystal layer 26R has the liquid crystal alignment pattern in which the optical axis 30A derived from the liquid crystal compound 30 changes while continuously rotating clockwise in the arrow X direction. Accordingly, the right circularly polarized light G_{R} of green light is reflected in a state where it is tilted in the arrow X direction with respect to the normal direction instead of being reflected in the normal direction.

The right circularly polarized light R_{R} of red light reflected from the R reflection cholesteric liquid crystal layer 26R of the second R reflecting layer 12b is incident into the G reflection member 14, transmits through the first G reflecting layer 14a, is converted into left circularly polarized light R_{L} of red light by the λ/2 plate 18G, transmits through the second G reflecting layer 14b, and is incident into the B reflecting layer.

The left circularly polarized light R_{L} of red light incident into the B reflection member 16 transmits through the first B reflecting layer 16a, is converted into right circularly polarized light R_{R} of red light by the λ/2 plate 18B, and transmits through the second B reflecting layer 16b. As a result, reflected light of the optical element 50 is obtained.

On the other hand, the light transmitted through the second R reflecting layer 12b is incident into the λ/2 plate 18R.

The circularly polarized light incident into and transmitted through the λ/2 plate 18R is converted into circularly polarized light having an opposite turning direction. Accordingly, the left circularly polarized light R_{L} of red light transmitted through the λ/2 plate 18R is converted into right circularly polarized light R_{R} of red light.

Next, the light transmitted through the λ/2 plate 18R is incident into the first R reflecting layer 12a. As in the second R reflecting layer 12b, the R reflection cholesteric liquid crystal layer 26R of the first R reflecting layer 12a also selectively reflects right circularly polarized light R_{R} of red light and allows transmission of the other light.

Accordingly, the right circularly polarized light R_{R} of red light is reflected from the R reflection cholesteric liquid crystal layer 26R. Here, the R reflection cholesteric liquid crystal layer 26R of the first R reflecting layer 12a and the R reflection cholesteric liquid crystal layer 26R of the second R reflecting layer 12b are the same. Accordingly, the right circularly polarized light R_{R} of red light reflected from the R reflection cholesteric liquid crystal layer 26R of the first R reflecting layer 12a and the right circularly polarized light R_{R} of red light reflected from the R reflection cholesteric liquid crystal layer 26R of the second R reflecting layer 12b are reflected in the same direction.

The right circularly polarized light R_{R} of red light reflected from the R reflection cholesteric liquid crystal layer 26R of the first R reflecting layer 12a is incident into and transmits through the λ/2 plate 18R to be converted into left circularly polarized light R_{L} of red light, transmits through the second R reflecting layer 12b, and is incident into the G reflection member 14.

The left circularly polarized light RL of red light incident into the G reflection member 14 transmits through the first G reflecting layer 14a, is converted into right circularly polarized light R_{R} of red light by the λ/2 plate 18G, transmits through the second G reflecting layer 14b, and is incident into the B reflection member 16.

The right circularly polarized light R_{R} of red light incident into the B reflection member 16 transmits through the first B reflecting layer 16a, is converted into left circularly polarized light R_{L} of red light by the λ/2 plate 18B, and transmits through the second B reflecting layer 16b. As a result, reflected light of the optical element 50 is obtained.

As described above, in the optical element 50 according to the embodiment of the present invention, right circularly polarized light and left circularly polarized light of red light, green light, and blue light can be reflected in the same direction. Therefore, a large amount of reflected light of each of red light, green light, and blue light can be reflected in a predetermined direction.

In addition, in the R reflection member 12, the G reflection member 14, and the B reflection member 16 of the optical element 50 including the cholesteric liquid crystal layers having different selective reflection center wavelengths, a permutation of the selective reflection center wavelengths of the cholesteric liquid crystal layers and a permutation of the single periods Λ of the liquid crystal alignment patterns match each other. Therefore, the wavelength dependence on the reflection angle of light is significantly reduced, and red light, green light, and blue light can be reflected substantially in the same direction. Therefore, by using the optical element 50 as a member for incidence and emission into and from a light guide plate, for example, in AR glasses, a red image, a green image, and a blue image can be propagated by one light guide plate without the occurrence of a color shift. As a result, an appropriate image can be displayed to a user.

The optical element according to the embodiment of the present invention is not limited as long as it includes the R reflection member 12, the G reflection member 14, and the B reflection member 16. The optical element according to the embodiment of the present invention may consist of only the R reflection member 12 and the G reflection member 14, may consist of only the R reflection member 12 and the B reflection member 16, or may consist of only the G reflection member 14 and the B reflection member 16.

This point will be described below.

### Third Embodiment

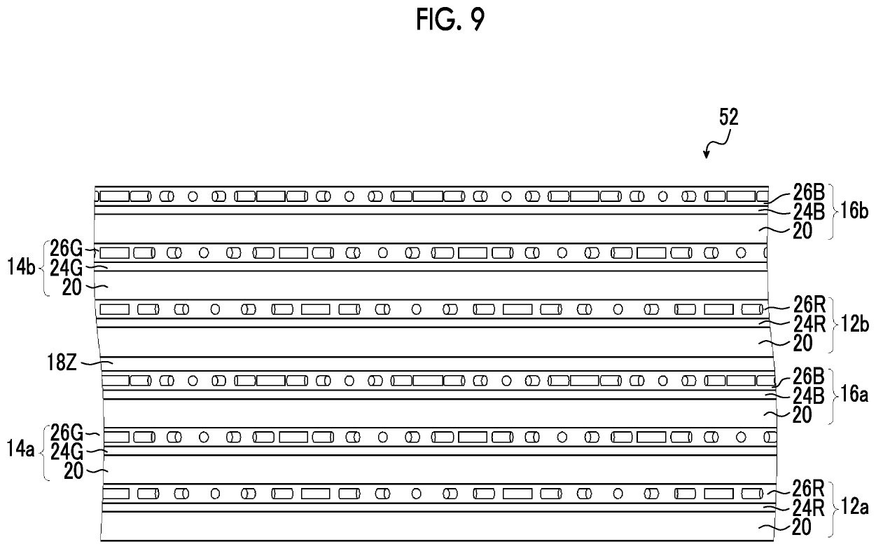

FIG. 9 is a conceptual diagram showing another example of the optical element according to the embodiment of the present invention. An optical element 52 shown in FIG. 9 includes a large number of the same members as those of the optical element shown in FIG. 8. Therefore, the same members are represented by the same reference numerals, and different members will be mainly described below.

In the optical element 50 shown in FIG. 8, the λ/2 plate is provided between the cholesteric liquid crystal layers for each combination of the cholesteric liquid crystal layers. On the other hand, the optical element 52 shown in FIG. 9 includes two laminates in which a plurality of reflecting layers including cholesteric liquid crystal layers having different selective reflection center wavelengths are laminated without providing the λ/2 plate therebetween, in which the λ/2 plate is provided between the two laminates.

In the optical element 52 shown in FIG. 9, the first R reflecting layer 12a and the second R reflecting layer 12b of the R reflection member 12 are separated from each other, the first G reflecting layer 14a and the second G reflecting layer 14b of the G reflection member 14 are separated from each other, and the first B reflecting layer 16a and the second B reflecting layer 16b of the B reflection member 16 are separated from each other.

In this state, the laminate including the first R reflecting layer 12a, the first G reflecting layer 14a, and the first B reflecting layer 16a and the laminate including the second R reflecting layer 12b, the second B reflecting layer 14b, and the second G reflecting layer 16b are prepared, and a λ/2 plate 18Z is disposed between the laminates.

That is, in this configuration, the cholesteric liquid crystal layers having different selective reflection center wavelengths are laminated. The λ/2 plate 18Z is disposed between the two laminates.

As a result, the optical element according to the embodiment of the present invention is formed by providing the λ/2 plate 18Z between the R reflection cholesteric liquid crystal layers 26R of the first R reflecting layer 12a and the second R reflecting layer 12b that are the cholesteric liquid crystal layers forming the combination of the cholesteric liquid crystal layers, between the G reflection cholesteric liquid crystal layers 26G of the first G reflecting layer 14a and the second G reflecting layer 14b that are the cholesteric liquid crystal layers forming the combination of the cholesteric liquid crystal layers, and between the B reflection cholesteric liquid crystal layers 26B of the first B reflecting layer 16a and the second B reflecting layer 16b that are the cholesteric liquid crystal layers forming the combination of the cholesteric liquid crystal layers.

Even in the optical element 52, right circularly polarized light and left circularly polarized light of red light, green light, and blue light are reflected, and a large amount of light reflected can be obtained.

That is, in a case where light is incident into the optical element 52, first, right circularly polarized light of blue light is reflected from the B reflection cholesteric liquid crystal layer 26B of the second B reflecting layer 16b, right circularly polarized light of green light is reflected from the G reflection cholesteric liquid crystal layer 26G of the second G reflecting layer 14b, and right circularly polarized light of red light is reflected from the R reflection cholesteric liquid crystal layer 26R of the second R reflecting layer 12b.

In addition, light transmitted through the laminate including the second R reflecting layer 12b, the second G reflecting layer 14b, and the second B reflecting layer 16b is incident into and transmits through the λ/2 plate 18Z to convert left circularly polarized light into right circularly polarized light.

In a case where light transmits through the λ/2 plate 18Z, right circularly polarized light of blue light is reflected from the B reflection cholesteric liquid crystal layer 26B of the first B reflecting layer 16a, right circularly polarized light of green light is reflected from the G reflection cholesteric liquid crystal layer 26G of the first G reflecting layer 14a, and right circularly polarized light of red light is reflected from the R reflection cholesteric liquid crystal layer 26R of the first R reflecting layer 12a.

As described above, as in the optical element 50, the optical element 52 includes the first R reflecting layer 12a and the second R reflecting layer 12b, the first G reflecting layer 14a and the second G reflecting layer 14b, and the first B reflecting layer 16a and the second B reflecting layer 16b.

Accordingly, right circularly polarized light and left circularly polarized light of red light, green light, and blue light can be reflected in the same direction. Therefore, a large amount of light reflected can be reflected in a predetermined direction.

In addition, in the R reflection member 12, the G reflection member 14, and the B reflection member 16 of the optical element 52 in the example shown in the drawing including the cholesteric liquid crystal layers having different selective reflection center wavelengths, a permutation of the selective reflection center wavelengths of the cholesteric liquid crystal layers and a permutation of the single periods Λ of the liquid crystal alignment patterns match each other. Therefore, the wavelength dependence on the reflection angle of light is significantly reduced, and red light, green light, and blue light can be reflected substantially in the same direction.

Further, in the optical element 52, the respective reflecting layers are also laminated such that the lengths of the selective reflection center wavelengths of the cholesteric liquid crystal layers sequentially increase toward the laminating direction of the reflection members. As in the above-described optical element 50, the effect caused by blue shift can be reduced.

In the optical element 52 shown in FIG. 9, the λ/2 plate 18Z may be the same as the above-described λ/2 plate 18 or the like.

Here, in the optical element 52, red light, green light, and blue light deals with one λ/2 plate 18Z. Therefore, it is preferable that the λ/2 plate 18Z is formed of a liquid crystal material having a reverse birefringence dispersion (using a phase difference plate having reverse dispersibility) such that light in a wide wavelength range can be dealt with the λ/2 plate 18Z.

### Fourth Embodiment

In all the above-described optical elements according to the embodiment of the present invention, the optical axis 30A of the liquid crystal compound 30 in the liquid crystal alignment pattern of the cholesteric liquid crystal layer continuously rotates only in the arrow X direction.

However, the present invention is not limited thereto, and various configurations can be used as long as the optical axis 30A of the liquid crystal compound 30 in the cholesteric liquid crystal layer continuously rotates in the in-plane direction.

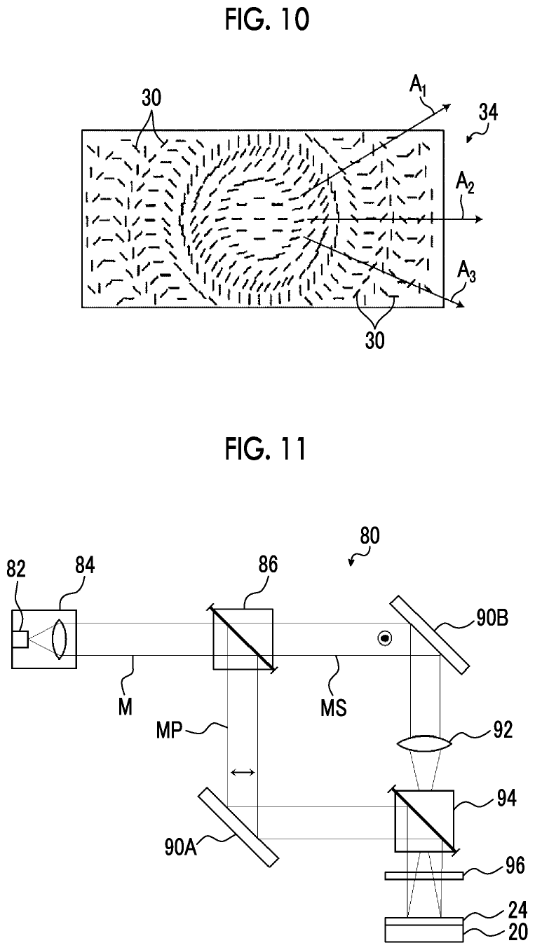

For example, a cholesteric liquid crystal layer 34 conceptually shown in a plan view of FIG. 10 can be used, in which a liquid crystal alignment pattern is a concentric circular pattern having a concentric circular shape where the in-plane direction in which the direction of the optical axis of the liquid crystal compound 30 changes while continuously rotating moves from an inside toward an outside.

Alternatively, a liquid crystal alignment pattern can also be used where the in-plane direction in which the direction of the optical axis of the liquid crystal compound 30 changes while continuously rotating is provided in a radial shape from the center of the cholesteric liquid crystal layer 34 instead of a concentric circular shape.

FIG. 10 shows only the liquid crystal compound 30 of the surface of the alignment film as in FIG. 3. However, as shown in FIG. 2, the cholesteric liquid crystal layer 34 has the helical structure in which the liquid crystal compound 30 on the surface of the alignment film is helically turned and laminated as described above.

Further, FIG. 10 shows only one cholesteric liquid crystal layer 34, and the optical element according to the embodiment of the present invention includes the combination of the cholesteric liquid crystal layers as described above. In addition, a preferable configuration and various aspects are the same as those of the above-described various embodiments.

In the cholesteric liquid crystal layer 34 shown in FIG. 10, the optical axis (not shown) of the liquid crystal compound 30 is a longitudinal direction of the liquid crystal compound 30.

In the cholesteric liquid crystal layer 34, the direction of the optical axis of the liquid crystal compound 30 changes while continuously rotating in a direction in which a large number of optical axes move to the outside from the center of the cholesteric liquid crystal layer 34, for example, a direction indicated by an arrow A₁, a direction indicated by an arrow A₂, a direction indicated by an arrow A₃, or . . . .

In addition, as a preferable aspect, for example, the direction of the optical axis of the liquid crystal compound changes while rotating in a radial direction from the center of the cholesteric liquid crystal layer 34 as shown in FIG. 10. In the aspect shown in FIG. 10, counterclockwise alignment is shown. The rotation directions of the optical axes indicated by the respective arrows A1, A2, and A3 in FIG. 10 are counterclockwise toward the outside from the center.

In circularly polarized light incident into the cholesteric liquid crystal layer 34 having the above-described liquid crystal alignment pattern, the absolute phase changes depending on individual local regions having different optical axes of the liquid crystal compound 30. At this time, the amount of change in absolute phase varies depending on the directions of the optical axes of the liquid crystal compound 30 into which circularly polarized light is incident.

This way, in the cholesteric liquid crystal layer 34 having the concentric circular liquid crystal alignment pattern, that is, the liquid crystal alignment pattern in which the optical axis changes while continuously rotating in a radial shape, incidence light can be reflected as diverging light or converging light depending on the rotation direction of the optical axis of the liquid crystal compound 30 and the direction of circularly polarized light to be reflected.

That is, by setting the liquid crystal alignment pattern of the cholesteric liquid crystal layer in a concentric circular shape, the optical element according to the embodiment of the present invention exhibits, for example, a function as a concave mirror or a convex mirror.

Here, in a case where the liquid crystal alignment pattern of the cholesteric liquid crystal layer is concentric circular such that the optical element functions as a concave mirror, it is preferable that the length of the single period Λ over which the optical axis rotates by 180° in the liquid crystal alignment pattern gradually decreases from the center of the cholesteric liquid crystal layer 34 toward the outer direction in the in-plane direction in which the optical axis continuously rotates.

As described above, the reflection angle of light with respect to an incidence direction increases as the length of the single period Λ in the liquid crystal alignment pattern decreases. Accordingly, the length of the single period Λ in the liquid crystal alignment pattern gradually decreases from the center of the cholesteric liquid crystal layer 34 toward the outer direction in the in-plane direction in which the optical axis continuously rotates. As a result, light can be further gathered, and the performance as a concave mirror can be improved.

In the present invention, in a case where the optical element functions as a convex mirror, it is preferable that the continuous rotation direction of the optical axis in the liquid crystal alignment pattern is reversed from the center of the cholesteric liquid crystal layer 34.

In addition, by gradually decreasing the length of the single period Λ over which the optical axis rotates by 180° from the center of the cholesteric liquid crystal layer 34 toward the outer direction in the in-plane direction in which the optical axis continuously rotates, light incident into the cholesteric liquid crystal layer can be further dispersed, and the performance as a convex mirror can be improved.

In the present invention, in a case where the optical element functions as a convex mirror, it is also preferable that a direction of circularly polarized light to be reflected from the cholesteric liquid crystal layer, that is, a sense of a helical structure is reversed to be opposite to that in the case of a concave mirror. That is, in a case where the optical element functions as a convex mirror, it is also preferable that the helical turning direction of the cholesteric liquid crystal layer is reversed.

In addition, by gradually decreasing the length of the single period Λ over which the optical axis rotates by 180° from the center of the cholesteric liquid crystal layer 34 toward the outer direction in the in-plane direction in which the optical axis continuously rotates, light reflected from the cholesteric liquid crystal layer can be further dispersed, and the performance as a convex mirror can be improved.

In a state where the helical turning direction of the cholesteric liquid crystal layer is reversed, it is preferable that the continuous rotation direction of the optical axis in the liquid crystal alignment pattern is reversed from the center of the cholesteric liquid crystal layer 34. As a result, the optical element can be made to function as a concave mirror.

In the present invention, in a case where the optical element is made to function as a convex mirror or a concave mirror, it is preferable that the optical element satisfies the following Expression (4).

Φ(r)=(π/λ)[(r²+f²)^{1/2}−f] Expression (4)

Here, r represents a distance from the center of a concentric circle and is represented by Expression “r=(x²+y²)^{1/2}”. x and y represent in-plane positions, and (x,y)=(0,0) represents the center of the concentric circle. Φ(r) represents an angle of the optical axis at the distance r from the center, λ represents the selective reflection center wavelength of the cholesteric liquid crystal layer, and f represents a desired focal length.

In the present invention, depending on the uses of the optical element, conversely, the length of the single period Λ in the concentric circular liquid crystal alignment pattern may gradually increase from the center of the cholesteric liquid crystal layer 34 toward the outer direction in the in-plane direction in which the optical axis continuously rotates.

Further, depending on the uses of the optical element such as a case where it is desired to provide a light amount distribution in reflected light, a configuration in which regions having partially different lengths of the single periods Λ in the in-plane direction in which the optical axis continuously rotates are provided can also be used instead of the configuration in which the length of the single period Λ gradually changes in the in-plane direction in which the optical axis continuously rotates.

Further, the optical element according to the embodiment of the present invention may include: a cholesteric liquid crystal layer in which the single period Λ is uniform over the entire surface; and a cholesteric liquid crystal layer in which regions having different lengths of the single periods Λ are provided. This point is also applicable to a configuration in which the optical axis continuously rotates only in the in-plane direction.

FIG. 11 conceptually shows an example of an exposure device that forms the concentric circular alignment pattern in the alignment film. Examples of the alignment film include the R alignment film 24R, the G alignment film 24G, and the B alignment film 24B.

An exposure device 80 includes: a light source 84 that includes a laser 82; a polarization beam splitter 86 that divides the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A to be incident into the polarization beam splitter 94. On the other hand, the S polarized light MS that is split by the polarization beam splitter 86 is reflected from the mirror 90B and is gathered by the lens 92 to be incident into the polarization beam splitter 94.

The P polarized light MP and the S polarized light MS are multiplexed by the polarization beam splitter 94, are converted into right circularly polarized light and left circularly polarized light by the λ/4 plate 96 depending on the polarization direction, and are incident into the alignment film 24 on the support 20.

Due to interference between the right circularly polarized light and the left circularly polarized light, the polarization state of light with which the alignment film 24 is irradiated periodically changes according to interference fringes. The intersection angle between the right circularly polarized light and the left circularly polarized light changes from the inside to the outside of the concentric circle. Therefore, an exposure pattern in which the pitch changes from the inside to the outside can be obtained. As a result, in the alignment film 24, a concentric circular alignment pattern in which the alignment state periodically changes can be obtained.

In the exposure device 80, the length Λ of the single period in the liquid crystal alignment pattern in which the optical axis of the liquid crystal compound 30 continuously rotates by 180° can be controlled by changing the refractive power of the lens 92 (the F number of the lens 92), the focal length of the lens 92, the distance between the lens 92 and the alignment film 24, and the like.

In addition, by adjusting the refractive power of the lens 92, the length Λ of the single period in the liquid crystal alignment pattern in the in-plane direction in which the optical axis continuously rotates can be changed. Specifically, In addition, the length Λ of the single period in the liquid crystal alignment pattern in the in-plane direction in which the optical axis continuously rotates can be changed depending on a light spread angle at which light is spread by the lens 92 due to interference with parallel light. More specifically, in a case where the refractive power of the lens 92 is weak, light is approximated to parallel light. Therefore, the length Λ of the single period in the liquid crystal alignment pattern gradually decreases from the inside toward the outside, and the F number increases. Conversely, in a case where the refractive power of the lens 92 becomes stronger, the length Λ of the single period in the liquid crystal alignment pattern rapidly decreases from the inside toward the outside, and the F number decreases.

This way, the configuration of changing the length of the single period Λ over which the optical axis rotates by 180° in the in-plane direction in which the optical axis continuously rotates can also be used in the configuration shown in FIGS. 1, 8, and 9 in which the optical axis 30A of the liquid crystal compound 30 continuously rotates only in the in-plane direction as the arrow X direction.

For example, by gradually decreasing the single period Λ of the liquid crystal alignment pattern in the arrow X direction, an optical element that reflects light to be gathered can be obtained.

In addition, by reversing the direction in which the optical axis in the liquid crystal alignment pattern rotates by 180°, an optical element that reflects light to be diffused only in the arrow X direction can be obtained. Likewise, by reversing the direction of circularly polarized light to be reflected (sense of a helical structure) from the cholesteric liquid crystal layer, an optical element that reflects light to be diffused only in the arrow X direction can be obtained. By reversing the direction in which the optical axis of the liquid crystal alignment pattern rotates by 180° in a state where the direction of circularly polarized light to be reflected from the cholesteric liquid crystal layer, an optical element that reflects light to be gathered can be obtained.

Further, depending on the uses of the optical element such as a case where it is desired to provide a light amount distribution in reflected light, a configuration in which regions having partially different lengths of the single periods Λ in the arrow X direction are provided can also be used instead of the configuration in which the length of the single period Λ gradually changes in the arrow X direction. For example, as a method of partially changing the single period Λ, for example, a method of scanning and exposing the photo-alignment film to be patterned while freely changing a polarization direction of laser light to be gathered can be used.

The optical element according to the embodiment of the present invention can be used for various uses where light is reflected at an angle other than the angle of specular reflection, for example, an optical path changing member, a light gathering element, a light diffusing element to a predetermined direction, a diffraction element, or the like in an optical device.

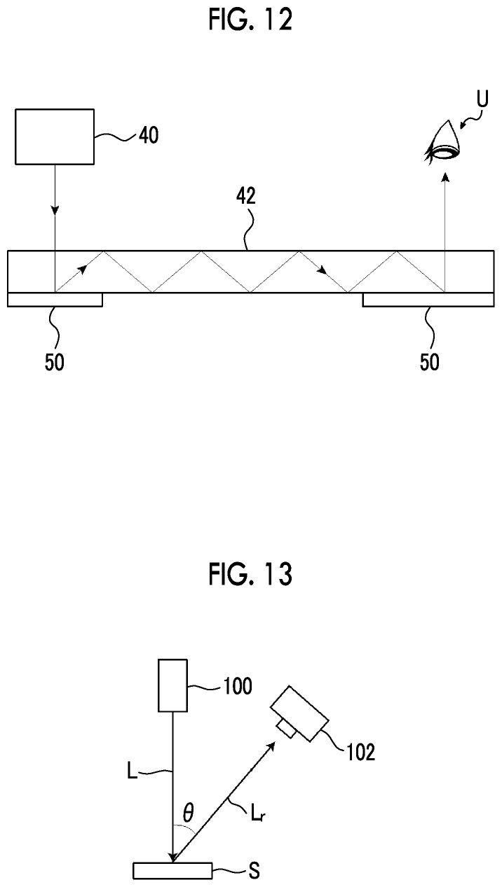

In a preferable example, as conceptually shown in FIG. 12, the optical element 50 according to the embodiment of the present invention shown in FIG. 8 can be used as a diffraction element that is provided to be spaced from the light guide plate 42 such that, in the above-described AR glasses, light (projection image) emitted from the display 40 is guided to the light guide plate 42 in the above-described AR glasses at a sufficient angle for total reflection and the light propagated in the light guide plate 42 is emitted from the light guide plate 42 to an observation position by a user U in the AR glasses.

As described above, in the optical element 50, the wavelength dependence of the reflection angle is small. Therefore, red light, green light, and blue light emitted from the display 40 can be reflected in the same direction. Therefore, with one light guide plate 42, even in a case where red image, green image, and blue image are propagated, a full color image having no color shift can be emitted from the light guide plate to the observation position by the user U in the AR glasses. Accordingly, by using the optical element 50 according to the embodiment of the present invention, the light guide plate of the AR glasses can be made thin and light as a whole, and the configuration of the AR glasses can be simplified.

The light guide element including the optical element according to the embodiment of the present invention is not limited to the configuration in which two optical elements according to the embodiment of the present invention spaced from each other are provided in the light guide plate 42 as shown in FIG. 12. A configuration in which only one optical element according to the embodiment of the present invention is provided in the light guide plate for incidence or emission of light into or from the light guide plate 42.

In the above-described example, the optical element according to the embodiment of the present invention is used as the optical element that reflects green light alone or three light components including red light, green light, and blue light. However, the present invention is not limited to this example, and various configurations can be used.

For example, the optical element according to the embodiment of the present invention may reflect only red light, may reflect only blue light, may reflect only infrared light, or may reflect only ultraviolet light.

In addition, the optical element according to the embodiment of the present invention also may be configured to reflect not only light of one color or two or more colors selected from visible light such as red light, green light, or blue light but also infrared light and/or ultraviolet light or to reflect only light other than visible light. Alternatively, the optical element according to the embodiment of the present invention also may be configured to reflect not only red light, green light, and blue light but also infrared light and/or ultraviolet light or to reflect only light other than visible light. Alternatively, the optical element according to the embodiment of the present invention also may be configured to reflect not only light of one color selected from visible light such as red light, green light, or blue light but also infrared light and/or ultraviolet light or to reflect only light other than visible light.

Hereinabove, the optical element according to the embodiment of the present invention has been described above. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

<Preparation of First G Reflecting Layer and Second G Reflecting Layer>

(Support and Saponification Treatment of Support)

As the support, a commercially available triacetyl cellulose film (manufactured by Fuji Film Co., Ltd., Z-TAC) was used.

The support was caused to pass through an induction heating roll at a temperature of 60° C. such that the support surface temperature was increased to 40° C.

Next, an alkali solution shown below was applied to a single surface of the support using a bar coater in an application amount of 14 mL (liter)/m², the support was heated to 110° C., and the support was transported for 10 seconds under a steam infrared electric heater (manufactured by Noritake Co., Ltd.).

Next, 3 mL/m² of pure water was applied to a surface of the support to which the alkali solution was applied using the same bar coater. Next, water cleaning using a foundry coater and water draining using an air knife were repeated three times, and then the support was transported and dried in a drying zone at 70° C. for 10 seconds. As a result, the alkali saponification treatment was performed on the surface of the support.

Alkali Solution

| | | |
|---|---|---|
| Potassium hydroxide | 4.70 | parts by mass |
| Water | 15.80 | parts by mass |
| Isopropanol | 63.70 | parts by mass |
| Surfactant | | |
| SF-1: C₁₄H₂₉O(CH₂CH₂O)₂OH | 1.0 | part by mass |
| Propylene glycol | 14.8 | parts by mass |

(Formation of Undercoat Layer)

The following undercoat layer-forming coating solution was continuously applied to the surface of the support on which the alkali saponification treatment was performed using a #8 wire bar. The support on which the coating film was formed was dried using warm air at 60° C. for 60 seconds and was dried using warm air at 100° C. for 120 seconds. As a result, an undercoat layer was formed.

Undercoat Layer-Forming Coating Solution

| | | |
|---|---|---|
| The following modified | 2.40 | parts by mass |
| polyvinyl alcohol | | |
| Isopropyl alcohol | 1.60 | parts by mass |
| Methanol | 36.00 | parts by mass |
| Water | 60.00 | parts by mass |

### Modified Polyvinyl Alcohol

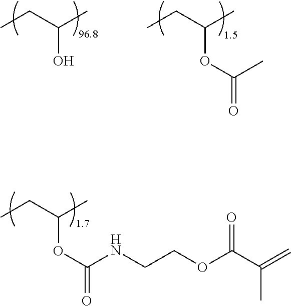

(Formation of Alignment Film)

The following alignment film-forming coating solution was continuously applied to the support on which the undercoat layer was formed using a #2 wire bar. The support on which the coating film of the alignment film-forming coating solution was formed was dried using a hot plate at 60° C. for 60 seconds. As a result, an alignment film was formed.

Alignment Film-Forming Coating Solution

| | | |
|---|---|---|
| The following material | 1.00 | part by mass |
| for photo-alignment | | |
| Water | 16.00 | parts by mass |
| Butoxyethanol | 42.00 | parts by mass |
| Propylene glycol | 42.00 | parts by mass |
| monomethyl ether | | |

—Material for Photo-Alignment—

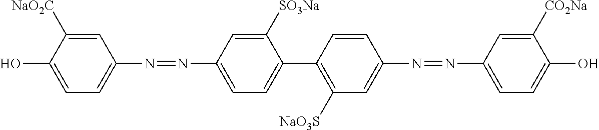

(Exposure of Alignment Film)

The alignment film was exposed using the exposure device shown in FIG. 5 to form an alignment film P-1 having an alignment pattern.

In the exposure device, a laser that emits laser light having a wavelength (325 nm) was used as the laser. The exposure dose of the interference light was 100 mJ/cm². The single period (the length over which the optical axis rotates by 180°) of an alignment pattern formed by interference of two laser beams was controlled by changing an intersection angle (intersection angle α) between the two beams.

(Formation of G Reflection Cholesteric Liquid Crystal Layer)

As the liquid crystal composition forming the cholesteric liquid crystal layer, the following composition A-1 was prepared. This composition A-1 is a liquid crystal composition forming a cholesteric liquid crystal layer (cholesteric liquid crystalline phase) that has a selective reflection center wavelength of 530 nm and reflects right circularly polarized light.

Composition A-1

| Rod-shaped liquid | 100.00 | parts by mass |
|---|---|---|
| crystal compound L-1 | | |
| Polymerization initiator | 3.00 | parts by mass |
| (IRGACURE (registered | | |
| trade name) 907, | | |
| manufactured by BASF SE) | | |
| Photosensitizer (KAYACURE | 1.00 | part by mass |
| DETX-S, manufactured | | |
| by Nippon Kayaku Co., Ltd.) | | |
| Chiral agent Ch-1 | 5.68 | parts by mass |
| Leveling agent T-1 | 0.08 | parts by mass |
| Methyl ethyl ketone | 268.20 | parts by mass |

Rod-Shaped Liquid Crystal Compound L-1

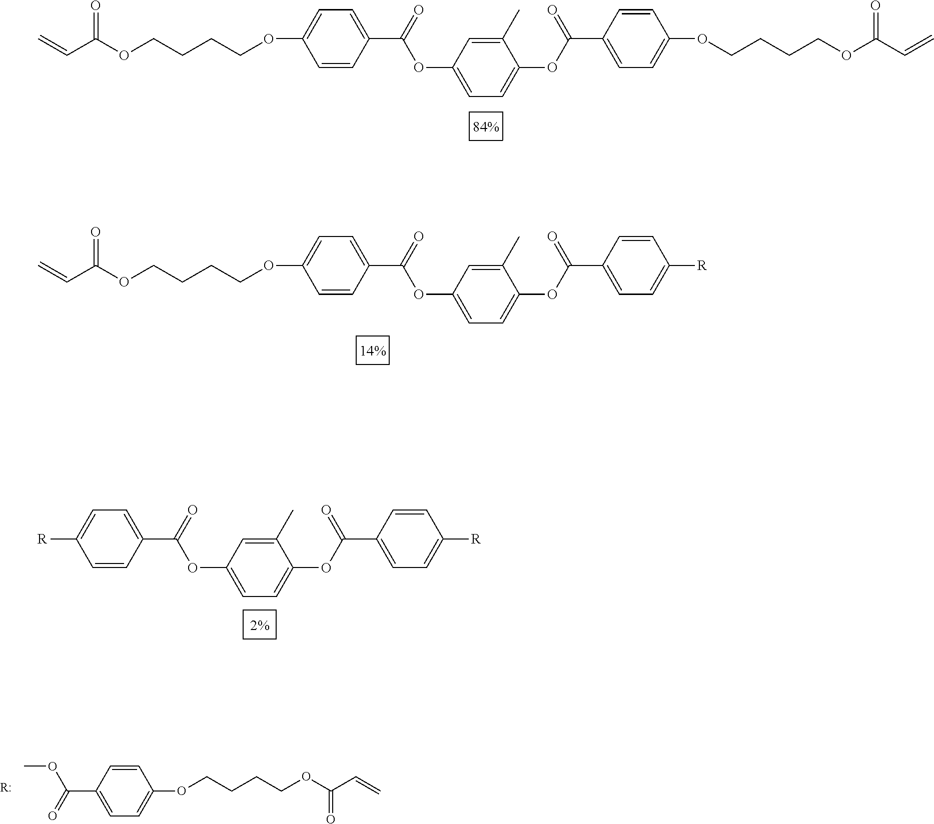

Chiral agent Ch-1

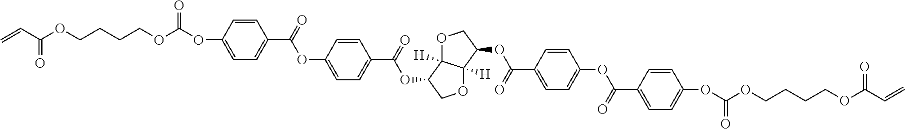 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

Leveling Agent T-1

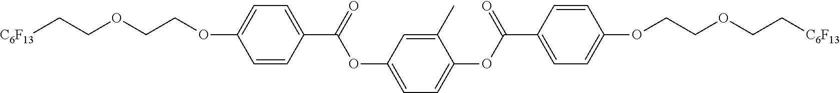

The G reflection cholesteric liquid crystal layer was formed by applying multiple layers of the composition A-1 to the alignment film P-1. The application of the multiple layers refers to repetition of the following processes including: preparing a first liquid crystal immobilized layer by applying the first layer-forming composition A-1 to the alignment film, heating the composition A-1, cooling the composition A-1, and irradiating the composition A-1 with ultraviolet light for curing; and preparing a second or subsequent liquid crystal immobilized layer by applying the second or subsequent layer-forming composition A-1 to the formed liquid crystal immobilized layer, heating the composition A-1, cooling the composition A-1, and irradiating the composition A-1 with ultraviolet light for curing as described above. Even in a case where the liquid crystal layer was formed by the application of the multiple layers such that the total thickness of the liquid crystal layer was large, the alignment direction of the alignment film was reflected from a lower surface of the liquid crystal layer to an upper surface thereof.

Regarding the first liquid crystal layer, the composition A-1 was applied to the alignment film P-1 to form a coating film, the coating film was heated using a hot plate at 95° C., the coating film was cooled to 25° C., and the coating film was irradiated with ultraviolet light having a wavelength of 365 nm at an irradiation dose of 100 mJ/cm² using a high-pressure mercury lamp in a nitrogen atmosphere. As a result, the alignment of the liquid crystal compound was immobilized. At this time, the thickness of the first liquid crystal layer was 0.2 μm.

Regarding the second or subsequent liquid crystal layer, the composition was applied to the first liquid crystal layer, and the applied composition was heated, cooled, and irradiated with ultraviolet light for curing under the same conditions as described above. As a result, a liquid crystal immobilized layer was prepared. This way, by repeating the application multiple times until the total thickness reached a desired thickness, and a G reflection cholesteric liquid crystal layer was obtained.

By performing the formation of the G reflection cholesteric reflecting layer on two supports, a first G reflecting layer and a second G reflecting layer were prepared.

In a case where a cross-section of the G reflecting layer was observed with a scanning electron microscope (SEM), the cholesteric liquid crystalline phase of the G reflecting layer had 8 pitches.

It was verified using a polarizing microscope that the G reflection cholesteric liquid crystal layer had a periodically aligned surface as shown in FIG. 3. In the liquid crystal alignment pattern of the G reflection cholesteric liquid crystal layer, the single period over which the optical axis derived from the liquid crystal compound rotated by 180° was 1.1 μm.

<Preparation of λ/2 Plate>

(Formation of Support and Alignment Film) A support was formed using the same method as that of the first G reflecting layer (the second G reflecting layer), a saponification treatment was performed on the support to form a undercoat layer, and an alignment film was formed.

(Exposure of Alignment Film)

By irradiating the formed alignment film with polarized ultraviolet light (50 mJ/cm², using an extra high pressure mercury lamp), the alignment film was exposed.

[Preparation of λ/2 Plate]

As the liquid crystal composition forming the λ/2 layer, the following composition R-1 was prepared.

Composition R-1

| | | |
|---|---|---|
| Liquid crystal compound L-2 | 42.00 | parts by mass |
| Liquid crystal compound L-3 | 42.00 | parts by mass |
| Liquid crystal compound L-4 | 16.00 | parts by mass |
| Polymerization initiator PI-1 | 0.50 | parts by mass |
| Leveling agent G-1 | 0.20 | parts by mass |
| Methyl ethyl ketone | 176.00 | parts by mass |
| Cyclopentanone | 44.00 | parts by mass |

—Liquid Crystal Compound L-2—

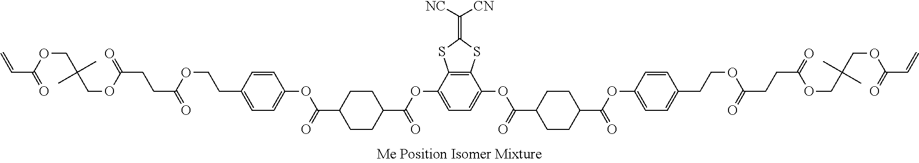 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

—Liquid Crystal Compound L-3—

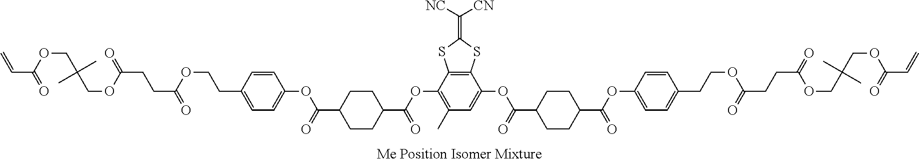 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

—Liquid Crystal Compound L-4—

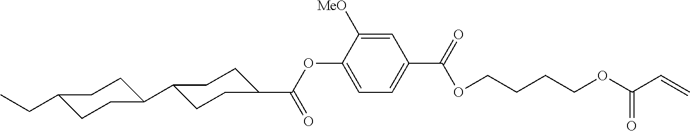 [SMILES: C=CC(=O)OCCCCOC(=O)c1ccc(OC(=O)C2CCC(C3CCC(CC)CC3)CC2)c(OC)c1]

—Polymerization initiator PI-1—

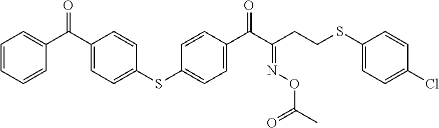 [SMILES: CC(=O)O/N=C(\CCSc1ccc(Cl)cc1)C(=O)c1ccc(Sc2ccc(C(=O)c3ccccc3)cc2)cc1]

—Leveling Agent G-1—

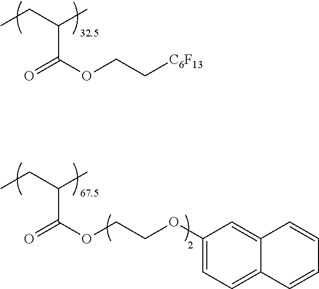

As the λ/2 plate, a layer formed of a reverse dispersion liquid crystal compound was formed.

The λ/2 plate was formed by applying the prepared composition R-1 to the alignment film. The applied coating film was heated to 70° C. using a hot plate and then was cooled to 65° C. Next, the coating film was irradiated with ultraviolet light having a wavelength of 365 nm at an irradiation dose of 500 mJ/cm² using a high-pressure mercury lamp in a nitrogen atmosphere. As a result, the alignment of the liquid crystal compound was immobilized.

As a result, a λ/2 plate was obtained. Re(530) of the prepared λ/2 plate was 265 nm.

<Preparation of Optical Element>

The first G reflecting layer, the second G reflecting layer, and the λ/2 plate prepared as described above were bonded to each other using an adhesive (manufactured by Soken Chemical & Engineering Co., Ltd., SK DINE 2057) in order of the first G reflecting layer, the λ/2 plate, and the second G reflecting layer as in the optical element shown in FIG. 1. As a result, an optical element was prepared. In the first G reflecting layer and the second G reflecting layer, directions in which the optical axes of the liquid crystal compounds continuously changed while rotating were made to match each other.

Hereinafter, the same adhesive was used.

### Example 2

<Preparation of First G Reflecting Layer and Second G Reflecting Layer>

An alignment film P-2 having an alignment pattern was formed using the same method as that of the alignment film P-1, except that, in a case where the alignment film was exposed using the exposure device shown in FIG. 5, the intersection angle between two light components was changed.

As the liquid crystal composition forming the cholesteric liquid crystal layer, the following composition B-1 was prepared. This composition B-1 is a liquid crystal composition forming a cholesteric liquid crystal layer that has a selective reflection center wavelength of 530 nm and reflects right circularly polarized light.

Composition B-1

| | | |
|---|---|---|
| Liquid crystal compound L-2 | 80.00 | parts by mass |
| Liquid crystal compound L-3 | 20.00 | parts by mass |
| Polymerization initiator (IRGACURE | | |
| (registered trade name) 907, | | |
| manufactured by BASF SE) | 5.00 | parts by mass |
| Chiral agent Ch-2 | 4.25 | parts by mass |
| MEGAFACE F444 (manufactured | 0.50 | parts by mass |
| by DIC Corporation) | | |
| Methyl ethyl ketone | 255.00 | parts by mass |

Liquid Crystal Compound L-2

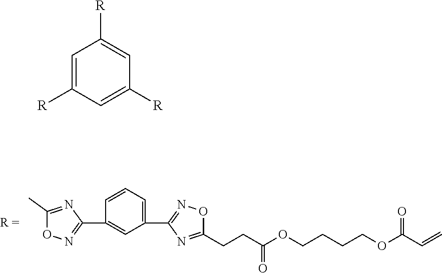

Liquid Crystal Compound L-3

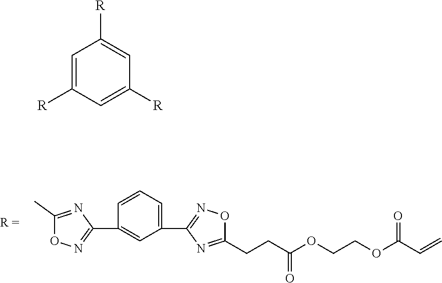

—Chiral agent Ch-2—

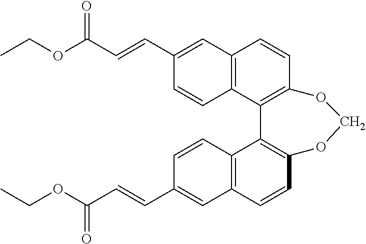

A G reflection cholesteric liquid crystal layer was formed using the same method as that of the G cholesteric liquid crystal layer according to Example 1, except that multiple layers of the composition B-1 were applied to the alignment film P-2. Using this G reflection cholesteric liquid crystal layer, a first G reflecting layer and a second G reflecting layer were prepared.

It was verified using a polarizing microscope that the G reflection cholesteric liquid crystal layer had a periodically aligned surface as shown in FIG. 3. In the liquid crystal alignment pattern of the G reflection cholesteric liquid crystal layer, the single period over which the optical axis derived from the liquid crystal compound rotated by 180° was 1.1 μm.

<Preparation of Optical Element>

Using the first G reflecting layer and the second G reflecting layer, an optical element was prepared with the same method as that of Example 1.

### Example 3

<Preparation of First G Reflecting Layer and Second G Reflecting Layer>

A composition A-2 was prepared using the same method as that of the composition A-1, except that the addition amount of the chiral agent Ch-1 was changed to 5.92 parts by mass. This composition A-2 is a liquid crystal composition forming a cholesteric liquid crystal layer that has a selective reflection center wavelength of 510 nm and reflects right circularly polarized light.

In addition, a composition A-3 was prepared using the same method as that of the composition A-1, except that the addition amount of the chiral agent Ch-1 was changed to 5.46 parts by mass. This composition A-3 is a liquid crystal composition forming a cholesteric liquid crystal layer that has a selective reflection center wavelength of 550 nm and reflects right circularly polarized light.

A G reflection cholesteric liquid crystal layer was formed using the same method as that of Example 1, except that the composition A-2 was used. Using this G reflection cholesteric liquid crystal layer, a first G reflecting layer was prepared. Two wavelengths of a half value transmittance of the G reflection cholesteric layer were 476 nm and 545 nm, and a range Δλₕ between the wavelengths was 69 nm. Accordingly, 0.8×Δλₕ=55.2.

In addition, a G reflection cholesteric liquid crystal layer was formed using the same method as that of Example 1, except that the composition A-3 was used. Using this G reflection cholesteric liquid crystal layer, a second G reflecting layer was prepared. Two wavelengths of a half value transmittance of the G reflection cholesteric layer were 515 nm and 586 nm, and a range Δλₕ between the wavelengths was 71 nm. Accordingly, 0.8×Δλₕ=56.8.

The selective reflection center wavelength of the G reflection cholesteric layer of the first G reflecting layer was 510 nm, the selective reflection center wavelength of the G reflection cholesteric layer of the second G reflecting layer was 550 nm, and a difference therebetween was 40 nm, which was less than or equal to “0.8×Δλₕ”.

The two wavelengths of the half value transmittance of the cholesteric liquid crystal layer were measured using a spectrophotometer (manufactured by Shimadzu Corporation, UV-3150).

<Preparation of Optical Element>

Using the first G reflecting layer and the second G reflecting layer, an optical element was prepared with the same method as that of Example 1.

### Comparative Example 1

An optical element was prepared using the same method as that of Example 1, except that the λ/2 plate was not used.

### Comparative Example 2

An optical element was prepared using the same method as that of Example 2, except that the λ/2 plate was not used.

### Comparative Example 3

An optical element was prepared using the same method as that of Example 3, except that the λ/2 plate was not used.

### Example 4

<Preparation of First G Reflecting Layer and Second G Reflecting Layer>

An alignment film P-3 was formed using the same method as that of the alignment film P-1, except that the exposure device shown in FIG. 11 was used as the exposure device for exposing the alignment film. By using the exposure device shown in FIG. 11, the single period of the alignment pattern gradually decreased toward the outer direction.

A G reflection cholesteric liquid crystal layer was formed using the same method as that of Example 1, except that multiple layers of the composition A-1 were applied to the alignment film P-3. Using this G reflection cholesteric liquid crystal layer, a first G reflecting layer and a second G reflecting layer were prepared.

It was verified using a polarizing microscope that the G reflection cholesteric liquid crystal layer had a periodically aligned surface having a concentric circular shape (radial shape) as shown in FIG. 10. In the liquid crystal alignment pattern of the R reflection cholesteric liquid crystal layer, regarding the single period over which the optical axis derived from the liquid crystal compound rotated by 180°, the single period of a center portion was 326 μm, the single period of a portion at a distance of 2.5 mm from the center was 10.6 μm, the single period of a portion at a distance of 5.0 mm from the center was 5.3 μm. This way, the single period decreased toward the outer direction.

Table 1 shows the single period of the portion at a distance of 5.0 mm from the center.

### Comparative Example 4

An optical element was prepared using the same method as that of Example 4, except that the λ/2 plate was not used.

### Example 5

<Preparation of First B Reflecting Layer and Second B Reflecting Layer>

An alignment film P-4 having an alignment pattern was formed using the same method as that of the alignment film P-1, except that, in a case where the alignment film was exposed using the exposure device shown in FIG. 5, the intersection angle between two light components was changed.

In addition, a composition A-4 forming the cholesteric liquid crystal layer was prepared using the same method as that of the composition A-1, except that the addition amount of the chiral agent Ch-1 was changed to 6.77 parts by mass. This composition A-4 is a liquid crystal composition forming a cholesteric liquid crystal layer that has a selective reflection center wavelength of 450 nm and reflects right circularly polarized light.

A B reflection cholesteric liquid crystal layer was formed using the same method as that of the G reflection cholesteric liquid crystal layer according to Example 1, except that multiple layers of the composition A-4 were applied to the alignment film P-4. Using this B reflection cholesteric liquid crystal layer, a first B reflecting layer and a second B reflecting layer were prepared.

It was verified using a polarizing microscope that the B reflection cholesteric liquid crystal layer had a periodically aligned surface as shown in FIG. 3. In the liquid crystal alignment pattern of the B reflection cholesteric liquid crystal layer, the single period over which the optical axis derived from the liquid crystal compound rotated by 180° was 0.9 μm.

<Preparation of λ/2 Plate>

A λ/2 plate was prepared using the same method as that of the λ/2 plate of Example 1, except that the thickness was adjusted such that Re(450) was 225 nm.

<Preparation of B Reflection Member>

The first B reflecting layer, the second B reflecting layer, and the λ/2 plate prepared as described above were bonded to each other using an adhesive in order of first B reflecting layer, the λ/2 plate, and the second B reflecting layer as in the optical element shown in FIG. 8. As a result, a B reflection member was prepared. In the first G reflecting layer and the second G reflecting layer, directions in which the optical axes of the liquid crystal compounds continuously changed while rotating were made to match each other.

<G Reflection Member>

As the optical element according to Example 1, the G reflection member was used.

<Preparation of Optical Element>

By bonding the B reflection member and the G reflection member using an adhesive, an optical element was prepared. In the B reflection member and the G reflection member, directions in which the optical axes of the liquid crystal compounds of the reflecting layers continuously changed while rotating were made to match each other.

### Comparative Example 5

An optical element was prepared using the same method as that of Example 5, except that the λ/2 plate was not used.

### Example 6

<Preparation of λ/2 Plate>

The same λ/2 plate as that of Example 1 was prepared.

<Preparation of Optical Element>

The same second G reflecting layer as that of Example 5 and the same second B reflecting layer as that of Example 1 were bonded in this order from the λ/2 plate side using an adhesive on one surface of the λ/2 plate. The same first B reflecting layer as that of Example 1 and the same first G reflecting layer as that of Example 5 were bonded in this order from the λ/2 plate side using an adhesive on another surface of the λ/2 plate. As a result, an optical element was prepared.

In each of the reflecting layers, directions in which the optical axes of the liquid crystal compounds continuously changed while rotating were made to match each other.

[Measurement of Reflection Angle]

In a case where light was incident into the prepared optical element from the normal direction (the front side, that is, a direction with an angle of 0° with respect to the normal line), angles (reflection angles) of reflected light of green light, or green light and blue light with respect to the incidence light were measured. Light was incident from a side where the second reflecting layer was positioned on the front surface.

Specifically, each of laser beams having an output center wavelength in a green light range (530 nm) and a blue light range (450 nm) was caused to be vertically incident into the prepare optical element from a position at a distance of 100 cm in the normal direction, and reflected light was captured using a screen disposed at a distance of 100 cm to calculate a reflection angle. In Examples 1 to 3 and Comparative Examples 1 to 3, the measurement was performed on only green light.

In addition, in Examples 5 and 6 and Comparative Examples 5 and 6, an average reflection angle of green light and blue light was calculated. Based the average reflection angle θₐᵥₑ and a maximum reflection angle θₐᵥₑ and a minimum reflection angle θₐᵥₑ among the reflection angles of the green light and the blue light, a wavelength dependence of reflection PE [%] was calculated from the following expression. As PE decreased, the wavelength dependence of reflection was low.

PE[%]=[(θₘₐₓ−θₘᵢₙ)/θₐᵥₑ]×100

A case where PE was 10% or lower was evaluated as A.

A case where PE was higher than 10% and 20% or lower was evaluated as B.

A case where PE was higher than 20% and 30% or lower was evaluated as C.

A case where PE was higher than 30% was evaluated as D.

In the optical elements prepared in Examples 4 and Comparative Example 4, laser light (green light) was caused to be incident from the normal direction into a position at a distance of 5.0 mm from the center of the concentric circle of the liquid crystal alignment pattern to measure the focal length.

[Measurement of Light Intensity]

Using a method shown in FIG. 13, a relative light intensity was measured.

In a case where light was incident into the prepared optical element from the front (direction with an angle of 0° with respect to the normal line), a relative light intensity of reflected light with respect to the incidence light was measured.

Specifically, laser light L having an output center wavelength of 530 nm was caused to be vertically incident from a light source 100 into the prepared optical element S. A light intensity of reflected light Lr reflected on a reflection angle θ was measured using a photodetector 102. A ratio between the light intensity of the reflected light Lr and the light intensity of the light L was obtained to obtain the value of the relative light intensity with respect to the incidence light (laser light L) of the reflected light Lr (reflected light Lr/laser light L). As the reflection angle θ, the reflection angle (in Example 4 and Comparative Example 4, the angle of reflected light from the point at which the focal length was measured) measured as described above was used.

For the optical element in which the reflecting layers including the B reflection cholesteric liquid crystal layers having a selective reflection center wavelength of 450 nm were laminated, measurement using the laser light having an output center wavelength of 450 nm as incidence light was performed such that the average value of the value of the measurement using the laser light L having a wavelength of 530 nm and the value of the measurement using the laser light having a wavelength of 450 nm was evaluated.

A case where the relative light intensity was 0.8 to 1.0 was evaluated as A,

a case where the relative light intensity was 0.5 or higher and lower than 0.8 was evaluated as B, and

a case where the relative light intensity was lower than 0.5 was evaluated as C.

The results are shown in the following table.

TABLE 1

| | | | | | | Comparative | Comparative | Comparative |
|---|---|---|---|---|---|---|---|---|
| | | | Example 1 | Example 2 | Example 3 | Example 1 | Example 2 | Example 3 |
| Layer | Second G | Composition | A-1 | B-1 | A-2 | A-1 | B-1 | A-1 |
| Configuration | Reflecting | Reflection | 530 | 530 | 510 | 530 | 530 | 510 |
| | Layer | Center | | | | | | |
| | | Wavelength | | | | | | |
| | | [nm] | | | | | | |
| | | Single Period | 1.1 | 1.1 | 1.1 | 1.1 | 1.1 | 1.1 |
| | | [μm] | | | | | | |
| | λ/2 Plate | Composition | R-1 | R-1 | R-1 | — | — | — |
| | First G | Composition | A-1 | B-1 | A-3 | A-1 | B-1 | A-1 |
| | Reflecting | Reflection | 530 | 530 | 550 | 530 | 530 | 550 |
| | Layer | Center | | | | | | |
| | | Wavelength | | | | | | |
| | | [nm] | | | | | | |
| | | Single Period | 1.1 | 1.1 | 1.1 | 1.1 | 1.1 | 1.1 |
| | | [μm] | | | | | | |

| | | | | | | | |
|---|---|---|---|---|---|---|---|
| Evaluation | Reflection | 30 | 30 | 30 | 30 | 30 | 30 |
| | Angle [°] | | | | | | |
| | Light Intensity | A | A | B | C | C | C |

| | | | | Comparative |
|---|---|---|---|---|
| | | | Example 4 | Example 4 |
| Layer | Second G | Composition | A-1 | A-1 |
| Configuration | Reflecting | Reflection | 530 | 530 |
| | Layer | Center | | |
| | | Wavelength | | |
| | | [nm] | | |
| | | Single | 5.3 | 5.3 |
| | | Period [μm] | | |
| | λ/2 Plate | Composition | R-1 | — |
| | First G | Composition | A-1 | A-1 |
| | Reflecting | Reflection | 530 | 530 |
| | Layer | Center | | |
| | | Wavelength | | |
| | | [nm] | | |
| | | Single | 5.3 | 5.3 |
| | | Period [μm] | | |

| | | | |
|---|---|---|---|
| Evaluation | Focal Length | 50 | 50 |
| | [mm] | | |
| | Light | A | C |
| | Intensity | | |

| | | | | Comparative |
|---|---|---|---|---|
| | | | Example 5 | Example 5 |
| Layer | Second B | Composition | A-4 | A-4 |
| Configuration | Reflecting | Reflection | 450 | 450 |
| | Layer | Center | | |
| | | Wavelength | | |
| | | [nm] | | |
| | | Single Period | 0.9 | 0.9 |
| | | [μm] | | |
| | λ/2 Plate | Composition | R-2 | — |
| | First B | Composition | A-4 | A-4 |
| | Reflecting | Reflection | 450 | 450 |
| | Layer | Center | | |
| | | Wavelength | | |
| | | [nm] | | |
| | | Single Period | 0.9 | 0.9 |
| | | [μm] | | |
| | Second G | Composition | A-1 | A-1 |
| | Reflecting | Reflection | 530 | 530 |
| | Layer | Center | | |
| | | Wavelength | | |
| | | [nm] | | |
| | | Single Period | 1.1 | 1.1 |
| | | [μm] | | |
| | λ/2 Plate | Composition | R-1 | — |
| | First G | Composition | A-1 | A-1 |
| | Reflecting | Reflection | 530 | 530 |
| | Layer | Center | | |
| | | Wavelength | | |
| | | [nm] | | |
| | | Single Period | 1.1 | 1.1 |
| | | [μm] | | |
| Evaluation | | Average | 30 | 30 |
| | | Reflection | | |
| | | Angle [°] | | |
| | | Light Intensity | A | C |
| | | PE | A | A |
| | | | | Comparative |
| | | | Example 6 | Example 6 |
| Layer | Second B | Composition | A-4 | A-4 |
| Configuration | Reflecting | Reflection | 450 | 450 |
| | Layer | Center | | |
| | | Wavelength | | |
| | | [nm] | | |
| | | Single Period | 0.9 | 0.9 |
| | | [μm] | | |
| | Second g | Composition | A-1 | A-1 |
| | Reflecting | Reflection | 530 | 530 |
| | Layer | Center | | |
| | | Wavelength | | |
| | | [nm] | | |
| | | Single Period | 1.1 | 1.1 |
| | | [μm] | | |
| | λ/2 Plate | Composition | R-3 | — |
| | First B | Composition | A-4 | A-4 |
| | Reflecting | Reflection | 450 | 450 |
| | Layer | Center | | |
| | | Wavelength | | |
| | | [nm] | | |
| | | Single Period | 0.9 | 0.9 |
| | | [μm] | | |
| | First G | Composition | A-1 | A-1 |
| | Reflecting | Reflection | 530 | 530 |
| | Layer | Center | | |
| | | Wavelength | | |
| | | [nm] | | |
| | | Single Period | 1.1 | 1.1 |
| | | [μm] | | |

| | | | |
|---|---|---|---|
| Evaluation | Average | 30 | 30 |
| | Reflection | | |
| | Angle [°] | | |
| | Light Intensity | A | C |
| | PE | A | A |

In this table, the reflection center wavelength refers to the selective reflection center wavelength of the cholesteric liquid crystal layer.

As shown in the table, in the optical element according to the embodiment of the present invention in which at least one combination of two cholesteric liquid crystal layers having the same turning direction of circularly polarized light to be reflected and including an overlapping portion in at least a part of selective reflection wavelength ranges and a λ/2 plate is provided between two cholesteric liquid crystal layers forming the combination of the cholesteric liquid crystal layers, the amount of light reflected can be increased. In particular, as shown in Examples 1, 2, and 4 to 6, by making the cholesteric liquid crystal layers forming the combination (reflecting layer pair) of the cholesteric liquid crystal layers match each other, a larger amount of light reflected can be obtained.

In addition, as shown in Examples 5 and 6, in a case where the optical element includes a combination of a plurality of cholesteric liquid crystal layers having different selective reflection center wavelengths, by making a permutation of the selective reflection center wavelengths of the cholesteric liquid crystal layers and a permutation of the single periods of the liquid crystal alignment patterns match each other, the wavelength dependence of reflection can be reduced.

The present invention is suitably applicable to various uses where light is reflected in an optical device, for example, a diffraction element that causes light to be incident into a light guide plate of AR glasses or emits light to the light guide plate.

### EXPLANATION OF REFERENCES

10, 50, 52: optical element
12: R reflection member
12a: first R reflecting layer
12b: second R reflecting layer
14: G reflection member
14a: first G reflecting layer
14b: second G reflecting layer
16: B reflection member
16a: first B reflecting layer
16b: second B reflecting layer
18, 18B, 18G, 18R, 18Z: λ/2 plate
20: support
24B: B alignment film
24G: G alignment film
24R: R alignment film
26B: B reflection cholesteric liquid crystal layer
26G: G reflection cholesteric liquid crystal layer
26R: R reflection cholesteric liquid crystal layer
30: liquid crystal compound
30A: optical axis
34: cholesteric liquid crystal layer
40: display
42: light guide plate
60, 80: exposure device
62, 82: laser
64, 84: light source
68, 86, 94: polarization beam splitter
70A, 70B, 90a, 90B: mirror
72A, 72B, 96: λ/4 plate
92: lens
100: semiconductor laser
102: linear polarizer
104: λ/4 plate
B_{L}: left circularly polarized light of blue light
B_{R}: right circularly polarized light of blue light
G_{L}: left circularly polarized light of green light
G_{R}: right circularly polarized light of green light
R_{L}: left circularly polarized light of red light
R_{R}: right circularly polarized light of red light
M: laser light
MA, MB: beam
MP: P polarized light
MS: S polarized light
P_{O}: linearly polarized light
P_{R}: right circularly polarized light
P_{L}: left circularly polarized light
Q: absolute phase
E: equiphase surface
U: user
S: sample
T: second support
L: light
Lₜ: diffracted light
Lₜ₁: emitted light
Lₜ₂: reflected light

What is claimed is:

1. An optical element comprising a plurality of cholesteric liquid crystal layers and a λ/2 plate that are laminated, each of the cholesteric liquid crystal layers being obtained by immobilizing a cholesteric liquid crystalline phase,
wherein the cholesteric liquid crystal layer has a liquid crystal alignment pattern in which a direction of an optical axis derived from a liquid crystal compound changes while continuously rotating in at least one in-plane direction,
in a case where, in the liquid crystal alignment pattern, a length over which the direction of the optical axis derived from the liquid crystal compound rotates by 180° in the in-plane direction in which the direction of the optical axis derived from the liquid crystal compound changes while continuously rotating is set as a single period,
at least one reflecting layer pair is provided, the reflecting layer pair being a combination of two cholesteric liquid crystal layers having the same turning direction of circularly polarized light to be reflected and including an overlapping portion in at least a part of selective reflection wavelength ranges, and
the λ/2 plate is provided between the cholesteric liquid crystal layers forming the reflecting layer pair.

2. The optical element according to claim 1,
wherein the cholesteric liquid crystal layers forming the reflecting layer pair have the same length of the single period.

3. The optical element according to claim 1,
wherein the cholesteric liquid crystal layers forming the reflecting layer pair have the same rotation direction and the same change direction of the optical axis derived from the liquid crystal compound.

4. The optical element according to claim 1,
wherein in a case where a range between two wavelengths of a half value transmittance of the cholesteric liquid crystal layers forming the reflecting layer pair is represented by Δλₕ, a difference between selective reflection center wavelengths is 0.8×Δλₕ nm or less.

5. The optical element according to claim 1,
wherein the cholesteric liquid crystal layers forming the reflecting layer pair are formed of the same cholesteric liquid crystal layer.

6. The optical element according to claim 1,
wherein a plurality of reflecting layer pairs are provided, and
selective reflection center wavelengths of the cholesteric liquid crystal layers forming the reflecting layer pair vary between the different reflecting layer pairs.

7. The optical element according to claim 6,
wherein the single periods of the cholesteric liquid crystal layers forming the reflecting layer pair vary between on the different reflecting layer pairs.

8. The optical element according to claim 7,
wherein a permutation of lengths of selective reflection center wavelengths and a permutation of lengths of the single periods in the cholesteric liquid crystal layers forming the reflecting layer pair match each other in the different reflecting layer pairs.

9. The optical element according to claim 6,
wherein the λ/2 plate is provided between the cholesteric liquid crystal layers forming the reflecting layer pair for each of the reflecting layer pairs.

10. The optical element according to claim 6 comprising:
two laminates in which a plurality of cholesteric liquid crystal layers having different selective reflection center wavelengths are laminated, each of the laminates consisting of the same cholesteric liquid crystal layer,
wherein the λ/2 plate is provided between the two laminates.
